(19) United States
(12) Patent Application Publication
(10) Pub. No.: US 2026/0330994 A1
(43) Pub. Date: Oct. 22, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventors: TATSUYA YAMAZAKI, TOKYO (JP); NAOMASA TAKAHASHI, TOKYO (JP); TATSUSHI NASHIDA, TOKYO (JP)

(21) Appl. No.: 19/113,104

(22) PCT Filed: Sep. 11, 2023
(86) PCT No.: PCT/JP2023/032950

§ 371 Date: Mar. 19, 2025

(30) Foreign Application Priority Data
Sep. 27, 2022 (JP) 2022-153672

(51) Int. Cl. G09B 9/042; B60W 40/08; G06T 7/70; G06V 20/59; G06V 40/10; G09B 9/05

(52) U.S. Cl. CPC G09B 9/042; B60W 40/08; G06T 7/70; G06V 20/59; G06V 40/10; G09B 9/05; B60W 2420/403; B60W 2540/223; G06T 2207/30196; G06T 2207/30268

(57) ABSTRACT

The present disclosure relates to an information processing apparatus, an information processing method, and a program that make it possible to realize driving simulation using a vehicle used in normal driving. Driving operation data representing the operation amount of driving operation performed on multiple types of operation systems for operating a vehicle is acquired, a control signal is supplied to multiple types of drive systems that drive the vehicle, and an action performed by the vehicle is controlled. In a travel mode, an action performed by the vehicle is controlled according to control data for controlling traveling of the vehicle according to the driving operation data, in a simulation mode, an action performed by the vehicle is controlled according to control data for controlling a behavior of the vehicle such that a behavior of the vehicle in a virtual space determined according to the driving operation data is reproduced, on the basis of a vehicle setting parameter acquired by communication from a second information processing apparatus, and when operation for giving an instruction to switch from the travel mode to the simulation mode is performed, it is decided whether or not to transition to the simulation mode, according to a stopped state of the vehicle.

### TECHNICAL FIELD

The present disclosure relates to an information processing apparatus, an information processing method, and a program, and in particular, relates to an information processing apparatus, an information processing method, and a program that make it possible to realize driving simulation using a vehicle used in normal driving.

### BACKGROUND ART

Conventionally, a vehicle used for driving simulation is not a vehicle used in normal driving, and driving simulation has been performed using operation systems (a steering wheel, an accelerator pedal, a brake pedal, etc.) for simulation.

For example, PTL 1 discloses a racing game apparatus that is used to perform a racing game by using an operation section provided with a steering, an accelerator, and a brake.

### CITATION LIST

### Patent Literature

[PTL 1]

JP 2000-229177A

### SUMMARY

### Technical Problem

Meanwhile, there has been a need to perform driving simulation using a vehicle used in normal driving, instead of using operation systems for simulation like the one described above.

The present disclosure has been made in view of such a situation, and is to make it possible to realize driving simulation using a vehicle used in normal driving.

### Solution to Problem

An information processing apparatus according to a first aspect of the present disclosure includes a communicating section that communicates with another information processing apparatus, an operation data acquiring section that acquires driving operation data representing an operation amount of driving operation performed on multiple types of operation systems for operating a vehicle, a vehicle action control section that supplies a control signal to multiple types of drive systems that drive the vehicle and controls an action performed by the vehicle, a travel mode control section that, in a travel mode in which traveling is performed using the vehicle, supplies, to the vehicle action control section, control data for controlling traveling of the vehicle according to the driving operation data, a simulation mode control section that, in a simulation mode in which driving simulation is performed using the vehicle, supplies, to the vehicle action control section, control data for controlling a behavior of the vehicle such that a behavior of the vehicle in a virtual space determined according to the driving operation data is reproduced, on the basis of a vehicle setting parameter acquired via the communicating section from the other information processing apparatus, and a stopped state deciding section that, when operation for giving an instruction to switch from the travel mode to the simulation mode is performed, decides whether or not to transition to the simulation mode, according to a stopped state of the vehicle.

An information processing method or a program according to the first aspect of the present disclosure includes communicating with another information processing apparatus, acquiring driving operation data representing an operation amount of driving operation performed on multiple types of operation systems for operating a vehicle, supplying a control signal to multiple types of drive systems that drive the vehicle and controlling an action performed by the vehicle, in a travel mode in which traveling is performed using the vehicle, causing an action performed by the vehicle to be controlled according to control data for controlling traveling of the vehicle according to the driving operation data, in a simulation mode in which driving simulation is performed using the vehicle, causing an action performed by the vehicle to be controlled according to control data for controlling a behavior of the vehicle such that a behavior of the vehicle in a virtual space determined according to the driving operation data is reproduced, on the basis of a vehicle setting parameter acquired by communication from the other information processing apparatus, and when operation for giving an instruction to switch from the travel mode to the simulation mode is performed, deciding whether or not to transition to the simulation mode, according to a stopped state of the vehicle.

In the first aspect of the present disclosure, communication with another information processing apparatus is performed, driving operation data representing an operation amount of driving operation performed on multiple types of operation systems for operating a vehicle is acquired, a control signal is supplied to multiple types of drive systems that drive the vehicle, an action performed by the vehicle is controlled, in a travel mode in which traveling is performed using the vehicle, an action performed by the vehicle is controlled according to control data for controlling traveling of the vehicle according to the driving operation data, in a simulation mode in which driving simulation is performed using the vehicle, an action performed by the vehicle is controlled according to control data for controlling a behavior of the vehicle such that a behavior of the vehicle in the virtual space determined according to the driving operation data is reproduced, on the basis of a vehicle setting parameter acquired by communication from the other information processing apparatus, and when operation for giving an instruction to switch from the travel mode to the simulation mode is performed, it is decided whether or not to transition to the simulation mode, according to a stopped state of the vehicle.

An information processing apparatus according to a second aspect of the present disclosure includes a communicating section that communicates with another information processing apparatus mounted on a vehicle, a virtual space generating section that performs driving simulation of virtual traveling of the vehicle in a virtual space according to driving operation data acquired from the vehicle via the communicating section and generates a simulation video by capturing images of the virtual space in all directions with the vehicle as a center by a virtual camera arranged in the virtual space such that the virtual camera corresponds to a predetermined position of the vehicle, and a video transformation processing section that implements, on the simulation video, video transformation processing based on vehicle position/posture data representing a position and a posture of the vehicle and occupant position/posture data including at least a viewpoint position of an occupant of the vehicle.

An information processing method or a program according to the other aspect of the present disclosure includes communicating with another information processing apparatus mounted on a vehicle, performing driving simulation of virtual traveling of the vehicle in a virtual space according to driving operation data acquired from the vehicle by the communication and generating a simulation video by capturing images of the virtual space in all directions with the vehicle as a center by a virtual camera arranged in the virtual space such that the virtual camera corresponds to a predetermined position of the vehicle, and implementing, on the simulation video, video transformation processing based on vehicle position/posture data representing a position and a posture of the vehicle and occupant position/posture data including at least a viewpoint position of an occupant of the vehicle.

In the second aspect of the present disclosure, communication with another information processing apparatus mounted on a vehicle is performed, driving simulation of virtual traveling of the vehicle in a virtual space is performed according to driving operation data acquired from the vehicle by the communication, a simulation video is generated by capturing images of the virtual space in all directions with the vehicle as a center by a virtual camera arranged in the virtual space such that the virtual camera corresponds to a predetermined position of the vehicle, and video transformation processing based on vehicle position/posture data representing a position and a posture of the vehicle and occupant position/posture data including at least a viewpoint position of an occupant of the vehicle is implemented on the simulation video.

### BRIEF DESCRIPTION OF DRAWINGS

FIG. 1 is a block diagram depicting a configuration example of an embodiment of a driving simulation system to which the present technology is applied.

FIG. 2 is a figure for explaining a configuration example of a vehicle adopting a by-wire system.

FIG. 3 depicts figures for explaining a configuration example of a garage apparatus.

FIG. 4 depicts figures for explaining an internal configuration example of the vehicle.

FIG. 5 depicts figures for explaining an example of a technique to specify a viewpoint of an occupant.

FIG. 6 is a block diagram depicting a configuration example of a garage system control apparatus.

FIG. 7 is a figure for explaining an example of expression, using garage displays, of a virtual plane as seen from a viewpoint position.

FIG. 8 is a block diagram depicting a configuration example of operation systems and drive systems of an in-vehicle control apparatus.

FIG. 9 is a block diagram depicting a configuration example of a video system and an audio system of the in-vehicle control apparatus.

FIG. 10 is a drawing depicting an example of data structures of vehicle parameters and an example of vehicle setting parameters.

FIG. 11 is a figure depicting the vehicle that is exhibiting a spinning behavior.

FIG. 12 is a drawing depicting an example of the vehicle parameters and the vehicle setting parameters.

FIG. 13 is a figure for explaining suspension setting data.

FIG. 14 is a figure for explaining seat setting data.

FIG. 15 is a flowchart for explaining an initial setup process on the side of a garage system.

FIG. 16 is a flowchart for explaining an initial setup process on the side of the vehicle.

FIG. 17 is a flowchart for explaining a driving simulation action process on the side of the garage system.

FIG. 18 is a flowchart for explaining a driving simulation action process on the side of the vehicle.

FIG. 19 is a flowchart for explaining a vehicle position/posture recognition process.

FIG. 20 is a flowchart for explaining an occupant position/posture recognition process.

FIG. 21 is a flowchart for explaining an in-video appearance control process.

FIG. 22 is a block diagram depicting a configuration example of a training system.

FIG. 23 is a flowchart for explaining unsupervised training.

FIG. 24 is a flowchart for explaining supervised training.

FIG. 25 is a flowchart for explaining learning.

FIG. 26 is a flowchart for explaining training performed one-on-one between a human teacher and a student.

FIG. 27 is a flowchart for explaining training performed one-to-many between a human teacher and students.

FIG. 28 is a flowchart for explaining training performed one-on-one or one-to-many between an AI teacher and a student or students.

FIG. 29 is a flowchart for explaining personal optimization of the vehicle.

FIG. 30 is a block diagram depicting a configuration example of an embodiment of a computer to which the present technology is applied.

### DESCRIPTION OF EMBODIMENTS

Hereinbelow, specific embodiments to which the present technology is applied are explained in detail with reference to the figures.

### <Configuration Example of Garage System>

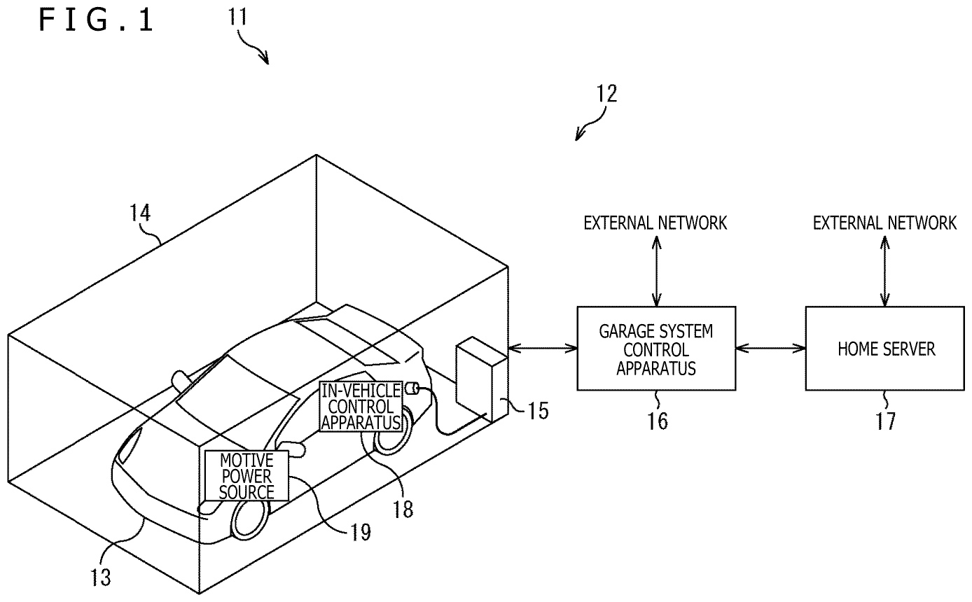

FIG. 1 is a block diagram depicting a configuration example of an embodiment of a driving simulation system to which the present technology is applied.

A driving simulation system 11 depicted in FIG. 1 includes a garage system 12 and a vehicle 13, and can realize driving simulation using the vehicle 13 used in normal driving by a user.

The garage system 12 includes a garage apparatus 14, a charging apparatus 15, a garage system control apparatus 16, and a home server 17.

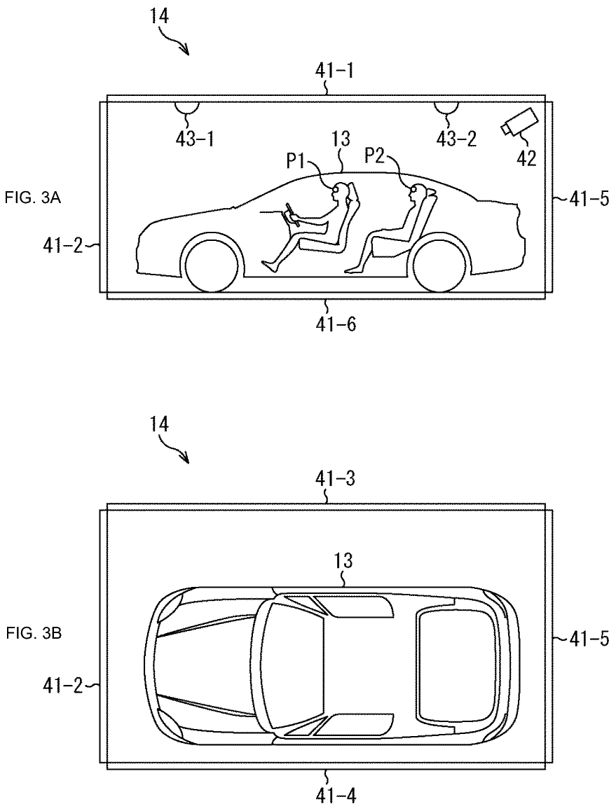

In addition to functions as a typical garage for storing the vehicle 13, the garage apparatus 14 has a function to display a video (hereinbelow, referred to as a simulation video) used in driving simulation, in such a manner as to surround the vehicle 13, as described later with reference to FIG. 3. In the present embodiment, the garage apparatus 14 is explained as one provided in a garage. Alternatively, the garage apparatus 14 may also be provided at a parking lot, a parking space, or the like.

By connecting a cable for charging and communication to the vehicle 13, it become possible for the charging apparatus 15 to charge the vehicle 13 and perform high-speed IP (Internet Protocol) communication between the garage system 12 and the vehicle 13.

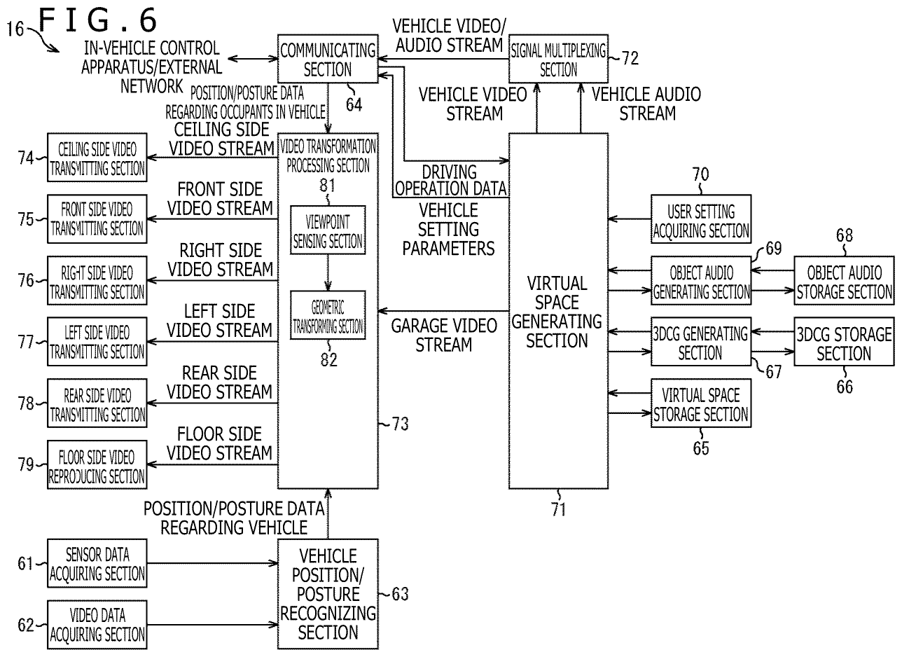

The garage system control apparatus 16 controls the garage system 12 when driving simulation is executed, by using data acquired via an external network, data accumulated in the home server 17, and the like. Note that a detailed configuration of the garage system control apparatus 16 is described later with reference to FIG. 6.

The home server 17 acquires data or the like that is necessary for the garage system control apparatus 16 to control the garage system 12, via an external network, and provides the data or the like to the garage system control apparatus 16.

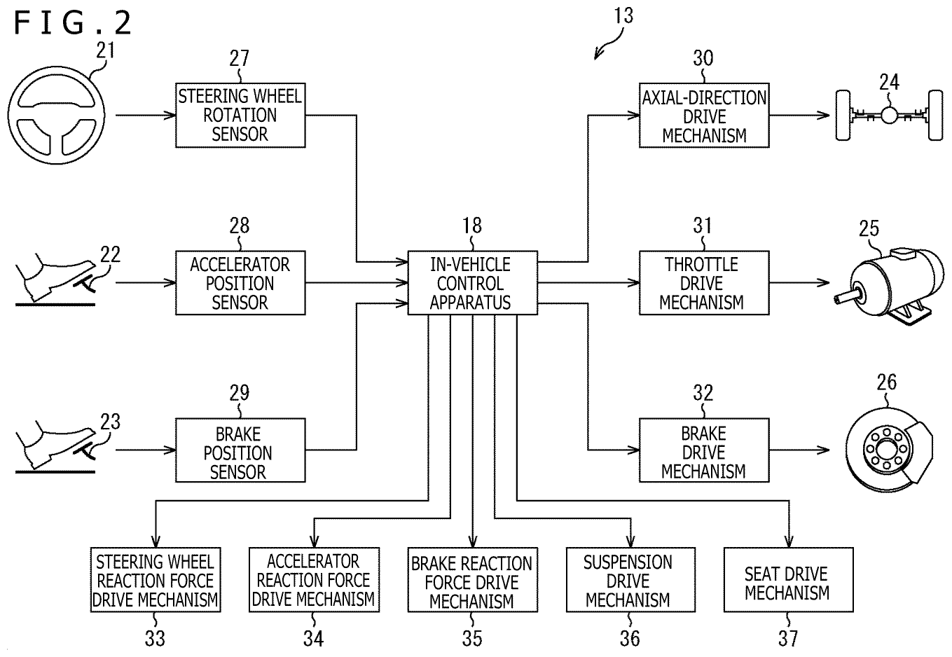

As described later with reference to FIG. 2, the vehicle 13 adopts a by-wire system configured to sense, by using sensors, driving operation performed on operation systems and transmit signals according to the driving operation electrically to drive systems via signal lines, instead of transmitting operation performed on the operation systems physically to the drive systems. In addition, the vehicle 13 includes an in-vehicle control apparatus 18 and a motive power source 19.

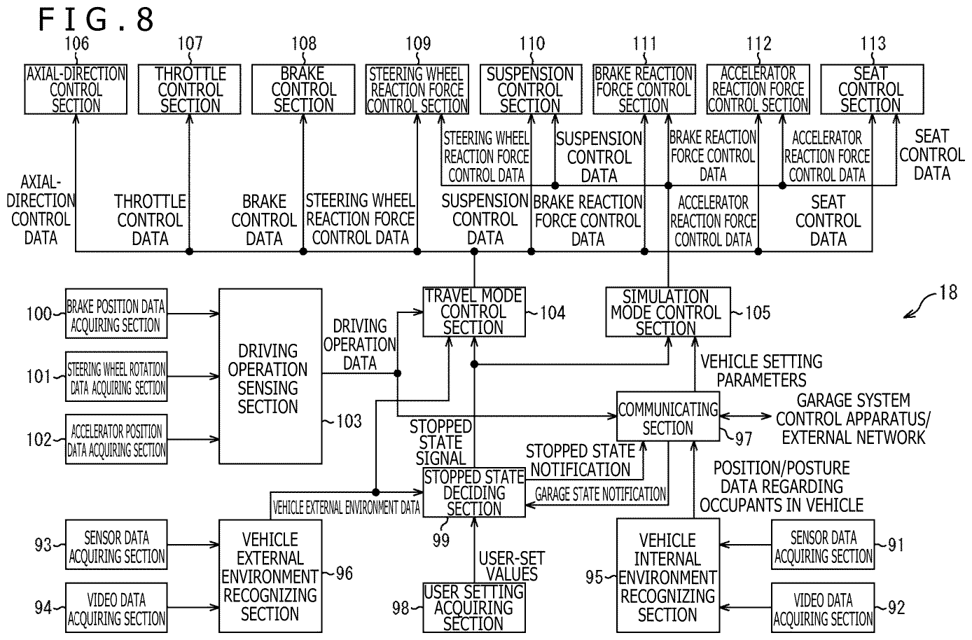

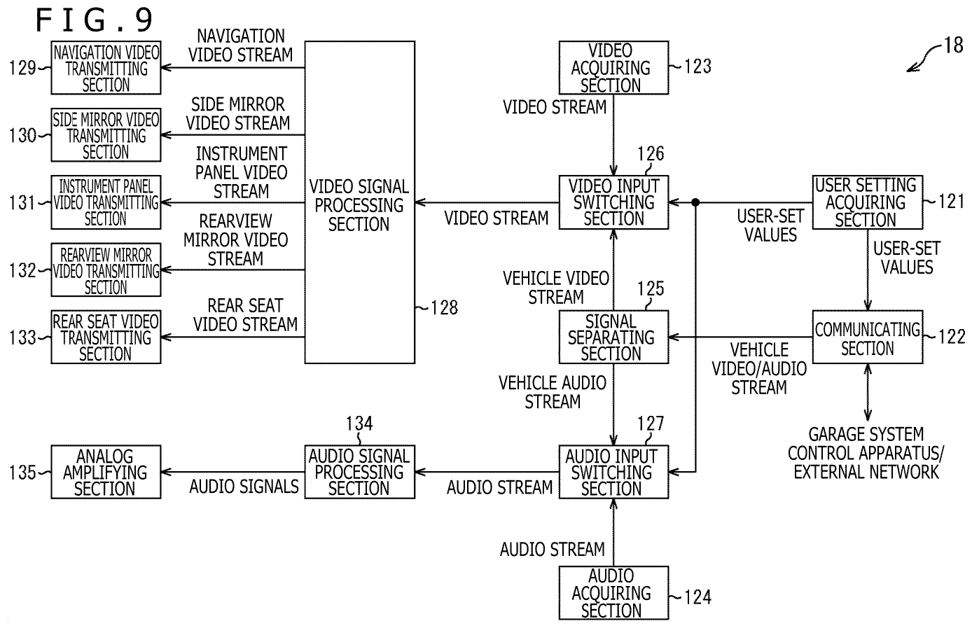

The in-vehicle control apparatus 18 communicates with the garage system control apparatus 16, and controls the vehicle 13 when driving simulation is executed. Note that a detailed configuration of the in-vehicle control apparatus 18 is described later with reference to FIG. 8 and FIG. 9.

For example, in a case where the vehicle 13 is an EV (Electric Vehicle), an electric motor using electricity as the energy source is used as the motive power source 19. In addition, in a case where the vehicle 13 is a gasoline vehicle, an internal combustion engine that uses gasoline as fuel is used as the motive power source 19, and, in a case where the vehicle 13 is a hybrid car, an internal combustion engine and an electric motor are used in combination as the motive power source 19.

The driving simulation system 11 is configured as described above, and driving simulation can be executed in a state where the vehicle 13 is garaged in the garage apparatus 14, by switching from a travel mode in which normal driving is performed using the vehicle 13 to a simulation mode in which driving simulation is performed using the vehicle 13.

A configuration example of the vehicle 13 adopting the by-wire system is explained with reference to FIG. 2.

As depicted in FIG. 2, the vehicle 13 includes a steering wheel 21, an accelerator pedal 22, a brake pedal 23, an axial-direction steering section 24, a throttle motor 25, a brake 26, a steering wheel rotation sensor 27, an accelerator position sensor 28, a brake position sensor 29, an axial-direction drive mechanism 30, a throttle drive mechanism 31, and a brake drive mechanism 32. Further, the vehicle 13 has a configuration in which operation systems such as the steering wheel 21, the accelerator pedal 22, and the brake pedal 23 and drive systems such as the axial-direction steering section 24, the throttle motor 25, and the brake 26 are connected to the in-vehicle control apparatus 18 electrically via signal lines but are disconnected physically.

The steering wheel rotation sensor 27 senses the rotation of the steering wheel 21 according to rotational operation by a driver of the vehicle 13, and outputs a steering wheel rotation signal representing the rotation amount of the steering wheel 21 to the in-vehicle control apparatus 18.

The accelerator position sensor 28 senses the position of the accelerator pedal 22 according to step-on operation performed by the driver of the vehicle 13, and outputs an accelerator position signal representing the step-on amount of the accelerator pedal 22 to the in-vehicle control apparatus 18.

The brake position sensor 29 senses the position of the brake pedal 23 according to step-on operation performed by the driver of the vehicle 13, and outputs a brake position signal representing the step-on amount of the brake pedal 23 to the in-vehicle control apparatus 18.

The axial-direction drive mechanism 30 drives the axial-direction steering section 24 according to an axial-direction control signal supplied from the in-vehicle control apparatus 18 on the basis of the steering wheel rotation signal output from the steering wheel rotation sensor 27. As a result, the axial-direction steering section 24 can steer tires of the vehicle 13 such that the angles of the tires become angles according to rotational operation performed on the steering wheel 21 by the driver of the vehicle 13.

The throttle drive mechanism 31 drives the throttle motor 25 according to a throttle control signal supplied from the in-vehicle control apparatus 18 on the basis of the accelerator position signal output from the accelerator position sensor 28.

As a result, the throttle motor 25 can cause the vehicle 13 to travel such that the vehicle 13 is accelerated according to step-on operation performed on the accelerator pedal 22 by the driver of the vehicle 13.

The brake drive mechanism 32 drives the brake 26 according to a brake control signal supplied from the in-vehicle control apparatus 18 on the basis of the brake position signal output from the brake position sensor 29. As a result, the brake 26 can cause the vehicle 13 to travel such that the vehicle 13 is decelerated according to step-on operation performed on the brake pedal 23 by the driver of the vehicle 13.

In the travel mode, the vehicle 13 configured as described above can travel owing to actions performed by the drive systems such as the axial-direction steering section 24, the throttle motor 25, and the brake 26 under the control of the in-vehicle control apparatus 18 according to operation performed on the operation systems such as the steering wheel 21, the accelerator pedal 22, and the brake pedal 23 by the driver of the vehicle 13.

On the other hand, in the simulation mode, the vehicle 13 executes driving simulation by supplying, to the garage system control apparatus 16, driving operation data representing operation performed on the operation systems such as the steering wheel 21, the accelerator pedal 22, and the brake pedal 23 by the driver of the vehicle 13. At this time, the drive systems such as the axial-direction steering section 24, the throttle motor 25, and the brake 26 remain stopped without performing actions. That is, the operation systems and the drive systems are linked with each other by-wire in the vehicle 13, and the vehicle 13 is configured such that the drive systems do not perform actions even if driving operation on the operation systems is performed in the simulation mode. Note that it is sufficient if at least one pair of corresponding ones in the operation systems and the drive systems is linked with each other by-wire. For example, if the steering wheel 21 and the axial-direction steering section 24 are linked with each other by-wire, it is possible to avoid wear of the tires caused by steering of the tires while the vehicle 13 is stopped.

Further, the vehicle 13 includes a steering wheel reaction force drive mechanism 33, an accelerator reaction force drive mechanism 34, a brake reaction force drive mechanism 35, a suspension drive mechanism 36, and a seat drive mechanism 37.

The steering wheel reaction force drive mechanism 33 generates, at the steering wheel 21, a steering wheel reaction force that resists the arm strength of the driver who performs rotational operation on the steering wheel 21, according to a steering wheel reaction force control signal supplied from the in-vehicle control apparatus 18.

The accelerator reaction force drive mechanism 34 generates, at the accelerator pedal 22, an accelerator reaction force that resists the leg strength of the driver who performs step-on operation on the accelerator pedal 22, according to an accelerator reaction force control signal supplied from the in-vehicle control apparatus 18.

The brake reaction force drive mechanism 35 generates, at the brake pedal 23, a brake reaction force that resists the leg strength of the driver who performs step-on operation on the brake pedal 23, according to a brake reaction force control signal supplied from the in-vehicle control apparatus 18.

The suspension drive mechanism 36 drives hydropneumatics suspensions (not depicted) that can adjust the vehicle height of the vehicle 13 by increasing or reducing air pressures, hydraulic pressures, or the like, and actively performs height control of the four wheels of the vehicle 13 independently.

The seat drive mechanism 37 drives an actuator (not depicted) built in the back and seat surface of each seat of the vehicle 13, and performs various types of adjustment actions of the seat surface and back of the seat at a certain degree of a speed along a time axis.

A configuration example of the garage apparatus 14 is explained with reference to FIG. 3.

A of FIG. 3 is a side view of an example of the schematic configuration of the garage apparatus 14 in which the vehicle 13 is garaged, and B of FIG. 3 is a plan view of an example of the schematic configuration of the garage apparatus 14 in which the vehicle 13 is garaged. In such a manner, driving simulation can be executed in a state where the vehicle 13 is garaged in the garage apparatus 14.

As depicted in FIG. 3, the garage apparatus 14 includes a ceiling side garage display 41-1, a front side garage display 41-2, a right side garage display 41-3, a left side garage display 41-4, a rear side garage display 41-5, a floor side garage display 41-6, a garage camera 42, and garage sensors 43-1 and 43-2.

The ceiling side garage display 41-1 is installed over the entire wall surface of the ceiling of the garage apparatus 14 in such a manner as to cover the wall surface, and displays a ceiling side simulation video supplied from the garage system control apparatus 16, at the time of execution of driving simulation.

The front side garage display 41-2 is installed over the entire wall surface of the front side of the garage apparatus 14 in such a manner as to cover the wall surface, and displays a front side simulation video supplied from the garage system control apparatus 16, at the time of execution of driving simulation.

The right side garage display 41-3 is installed over the entire wall surface of the right side of the garage apparatus 14 in such a manner as to cover the wall surface, and displays a right side simulation video supplied from the garage system control apparatus 16, at the time of execution of driving simulation.

The left side garage display 41-4 is installed over the entire wall surface of the left side of the garage apparatus 14 in such a manner as to cover the wall surface, and displays a left side simulation video supplied from the garage system control apparatus 16, at the time of execution of driving simulation.

The rear side garage display 41-5 is installed over the entire wall surface of the rear side of the garage apparatus 14 in such a manner as to cover the wall surface, and displays a rear side simulation video supplied from the garage system control apparatus 16, at the time of execution of the driving simulation.

The floor side garage display 41-6 is installed over the entire wall surface of the floor side of the garage apparatus 14 in such a manner as to cover the wall surface, and displays a floor side simulation video supplied from the garage system control apparatus 16, at the time of execution of driving simulation.

Note that, in a case where it is not necessary to make distinctions between the ceiling side garage display 41-1, the front side garage display 41-2, the right side garage display 41-3, the left side garage display 41-4, the rear side garage display 41-5, and the floor side garage display 41-6, these are referred to as garage displays 41 hereinbelow. For example, display units adopting such a light emission scheme as an LED (Light Emitting Diode) or an OLED (Organic Light Emitting Diode) are used as the garage displays 41, and multiple display units can be used by being tiled.

In order to recognize the position and the posture of the vehicle 13, the garage camera 42 captures images of the vehicle 13 garaged in the garage apparatus 14, acquires a video, and supplies video data thereof to the garage system control apparatus 16.

In order to recognize the position and the posture of the vehicle 13, the garage sensors 43-1 and 43-2 supply, to the garage system control apparatus 16, sensor data obtained by sensing the positions of multiple markers (e.g., retroreflective materials, etc.) attached to the body of the vehicle 13, for example. Note that, in a case where it is not necessary to make distinctions between the garage sensors 43-1 and 43-2, these are simply referred to as garage sensors 43 hereinbelow. In addition, although the two garage sensors 43-1 and 43-2 are depicted in the example depicted in FIG. 3, the position and the posture of the vehicle 13 may also be sensed by one garage sensor 43 or three or more garage sensors 43. Alternatively, the relative relation between the positions and the postures of the vehicle 13 and the garage apparatus 14 may be sensed by an outside-vehicle sensor (not depicted) provided to the vehicle 13.

Note that, in the driving simulation system 11, the position and the posture of the vehicle 13 may also be recognized by sensing four points at which the tires of the vehicle 13 contact, with use of positioning sensors (e.g., piezoelectric elements, etc.) embedded in the floor side of the garage apparatus 14. Alternatively, in the driving simulation system 11, the position and the posture of the vehicle 13 may also be recognized by acquiring shape data such as point clouds or meshes of the vehicle 13 with use of a measurement apparatus which is a combination of an RGB camera, a depth sensor, and the like.

At the time of execution of driving simulation, the garage apparatus 14 configured as described above can display a simulation video seen from a viewpoint position P of an occupant in the vehicle 13 on the garage displays 41 arranged in such a manner as to surround the vehicle 13.

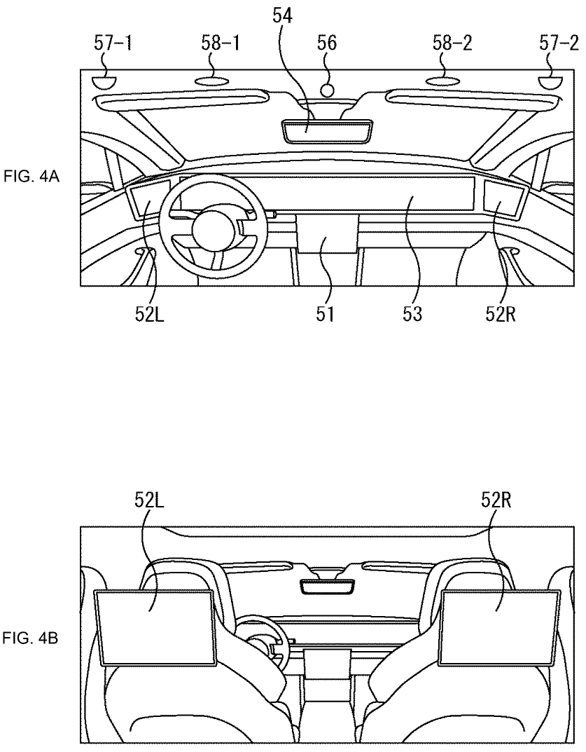

An internal configuration example of the vehicle 13 is explained with reference to FIG. 4.

A of FIG. 4 depicts an internal configuration example of the vehicle 13 as seen from the driver's seat and the passenger seat in the forward direction, and B of FIG. 4 depicts an internal configuration example of the vehicle 13 as seen from the rear seats in the forward direction.

As depicted in FIG. 4, a navigation display 51, side mirror displays 52L and 52R, an instrument panel display 53, a rearview mirror display 54, rear seat displays 55L and 55R, an in-vehicle camera 56, in-vehicle sensors 57-1 and 57-2, and speakers 58-1 and 58-2 are arranged inside the vehicle 13.

For example, the navigation display 51 arranges, on a map image, a vehicle mark representing the traveling position of the vehicle 13, on the basis of a navigation video stream supplied from the in-vehicle control apparatus 18, and displays a navigation video in which the vehicle mark moves on the map image. In addition, the navigation display 51 displays, in the travel mode, an actual navigation video according to positional information regarding the vehicle 13, and displays, in the simulation mode, a virtual navigation video according to the traveling position in the virtual space based on driving simulation.

For example, the side mirror displays 52L and 52R display side mirror videos captured in the rear direction of the vehicle 13 by side mirror cameras installed on the left side and right side of the vehicle 13, on the basis of a side mirror video stream supplied from the in-vehicle control apparatus 18. In addition, the side mirror displays 52L and 52R display, in the travel mode, actual side mirror videos captured by side mirror cameras provided to the vehicle 13, and displays, in the simulation mode, virtual side mirror videos captured by side mirror cameras provided in the virtual space based on driving simulation.

For example, the instrument panel display 53 displays an instrument panel video representing various types of instrument data such as the traveling speed and engine revolution speed of the vehicle 13, on the basis of an instrument panel video stream supplied from the in-vehicle control apparatus 18. In addition, the instrument panel display 53 displays, in the travel mode, an actual instrument panel video based on driving by the vehicle 13, and displays, in the simulation mode, a virtual instrument panel video based on driving simulation.

For example, the rearview mirror display 54 displays a rearview mirror video captured in the rear direction of the vehicle 13 by a rearview mirror camera installed on the rear side of the vehicle 13, on the basis of a rearview mirror video stream supplied from the in-vehicle control apparatus 18. In addition, the rearview mirror display 54 displays, in the travel mode, an actual rearview mirror video captured by a rearview mirror camera provided to the vehicle 13, and displays, in the simulation mode, a virtual rearview mirror video captured by a rearview mirror camera provided in the virtual space based on driving simulation.

For example, the rear seat displays 55L and 55R display rear seat viewpoint videos captured by external cameras provided outside the vehicle 13, on the basis of a rear seat video stream supplied from the in-vehicle control apparatus 18, the rear seat viewpoint videos being videos that are assumed to be seen ahead of the rear seat displays 55L and 55R from the viewpoints of occupants of the rear seats. In addition, the rear seat displays 55L and 55R display, in the travel mode, actual rear seat viewpoint videos captured by external cameras provided to the vehicle 13, and displays, in the simulation mode, virtual rear seat viewpoint videos captured by external cameras provided in the virtual space based on driving simulation.

In order to recognize the positions and the postures of occupants of the vehicle 13, the in-vehicle camera 56 captures and acquires a video of the occupants of the vehicle 13, and supplies video data thereof to the in-vehicle control apparatus 18.

In order to recognize the positions and the postures of the occupants of the vehicle 13, the in-vehicle sensors 57-1 and 57-2 supply, to the in-vehicle control apparatus 18, sensor data obtained by sensing the distances to (depths of) the occupants. Note that, in a case where it is not necessary to make distinctions between the in-vehicle sensors 57-1 and 57-2, these are simply referred to as in-vehicle sensors 57 hereinbelow. In addition, although the two in-vehicle sensors 57-1 and 57-2 are depicted in the example depicted in FIG. 3, the positions and the postures of occupants may also be sensed by one in-vehicle sensor 57 or three or more in-vehicle sensors 57.

The speakers 58-1 and 58-2 output audio based on audio signals supplied from the in-vehicle control apparatus 18. For example, the speakers 58-1 and 58-2 output, in the travel mode, audio reproduced by an audio system mounted on the vehicle 13, and output, in the simulation mode, object audio emitted from objects in the virtual space based on driving simulation.

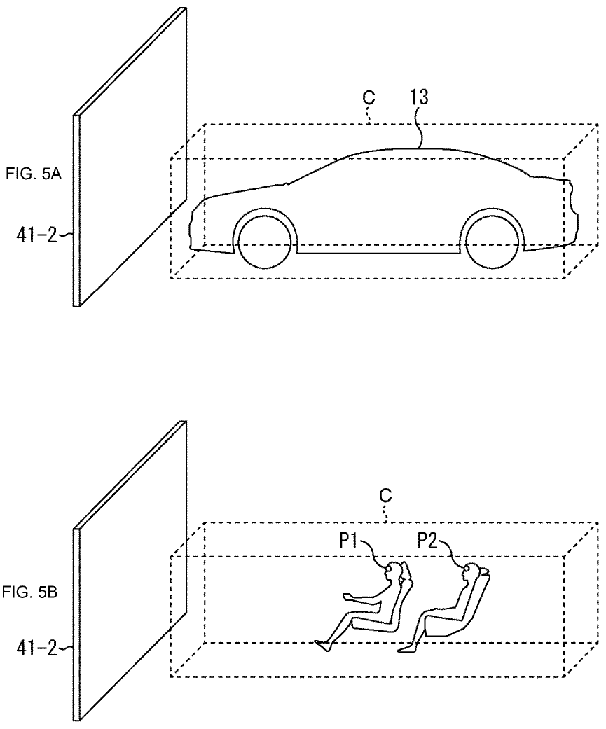

An example of a technique to specify the viewpoint position P of an occupant is explained with reference to FIG. 5.

For example, the garage system control apparatus 16 recognizes the position and the posture of the vehicle 13 relative to each garage display 41 of the garage apparatus 14 on the basis of video data supplied from the garage camera 42 and sensor data supplied from the garage sensors 43. As a result, for example, as depicted in A of FIG. 5, the garage system control apparatus 16 can acquire position/posture data regarding the vehicle 13 represented by a cuboid space C in which the vehicle 13 is inscribed, relatively to the front side garage display 41-2.

In addition, the in-vehicle control apparatus 18 recognizes the position and the posture of an occupant and recognizes the viewpoint position P (viewpoint position and line-of-sight direction) of the occupant, relatively to the vehicle 13 on the basis of video data supplied from the in-vehicle camera 56 and sensor data supplied from the in-vehicle sensors 57. Then, in addition to information representing the position and the posture of the occupant, the in-vehicle control apparatus 18 acquires position/posture data regarding the occupant including information representing the viewpoint position and line-of-sight direction of the occupant, and supplies the position/posture data to the garage system control apparatus 16. As a result, the garage system control apparatus 16 can recognize the position, posture, viewpoint position, and line-of-sight direction of the occupant relatively to the cuboid space C in which the vehicle 13 is inscribed like the one depicted in B of FIG. 5.

Accordingly, for example, the garage system control apparatus 16 can specify the viewpoint position P of the occupant relative to the front side garage display 41-2 on the basis of the cuboid space C relative to the front side garage display 41-2 and the viewpoint position P of the occupant relative to the cuboid space C.

Note that the position/posture data regarding the vehicle 13 and the position/posture data regarding an occupant may also be specified by a method other than the method explained here.

For example, the position/posture data regarding the vehicle 13 may also be expressed using coordinates of the vehicle 13 measured with part of the vehicle 13 (a position where the front right tire touches the ground, etc.) as the center. In this case, the position/posture data regarding the vehicle 13 includes positional information regarding the part of the vehicle 13 to which the center of the vehicle coordinate system corresponds.

### <Configuration Example of Garage System Control Apparatus>

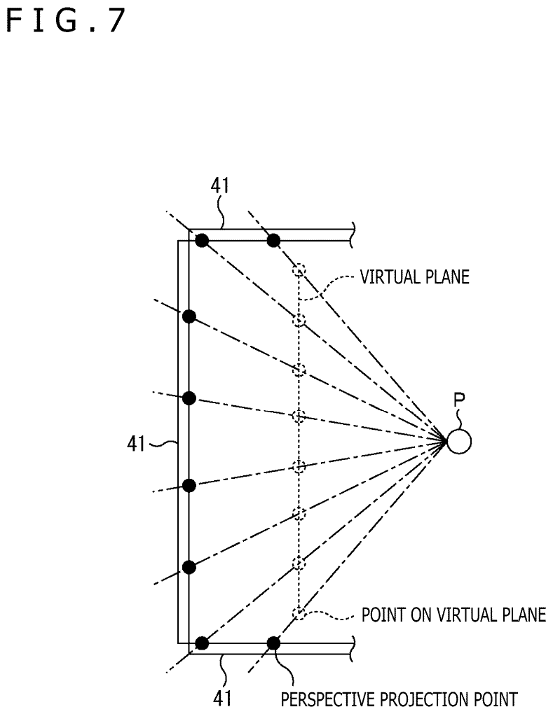

A configuration example of the garage system control apparatus 16 is explained with reference to FIG. 6 and FIG. 7.

FIG. 6 is a block diagram depicting the configuration example of the garage system control apparatus 16.

As depicted in FIG. 6, the garage system control apparatus 16 includes a sensor data acquiring section 61, a video data acquiring section 62, a vehicle position/posture recognizing section 63, a communicating section 64, a virtual space storage section 65, a 3DCG storage section 66, a 3DCG generating section 67, an object audio storage section 68, an object audio generating section 69, a user setting acquiring section 70, a virtual space generating section 71, a signal multiplexing section 72, a video transformation processing section 73, a ceiling side video transmitting section 74, a front side video transmitting section 75, a right side video transmitting section 76, a left side video transmitting section 77, a rear side video transmitting section 78, and a floor side video transmitting section 79.

The sensor data acquiring section 61 acquires the sensor data supplied from the garage sensors 43, and supplies the sensor data to the vehicle position/posture recognizing section 63.

The video data acquiring section 62 acquires the video data supplied from the garage camera 42, and supplies the video data to the vehicle position/posture recognizing section 63.

On the basis of the sensor data supplied from the sensor data acquiring section 61 and the video data supplied from the video data acquiring section 62, the vehicle position/posture recognizing section 63 recognizes the position and the posture of the vehicle 13 garaged in the garage apparatus 14, and acquires the position/posture data regarding the vehicle 13. For example, the vehicle position/posture recognizing section 63 can acquire the position/posture data regarding the vehicle 13 represented by the cuboid space C in which the vehicle 13 is inscribed like the one described above with reference to FIG. 5. Further, the vehicle position/posture recognizing section 63 supplies the position/posture data regarding the vehicle 13 to the video transformation processing section 73.

The communicating section 64 communicates with the in-vehicle control apparatus 18 and an external network. For example, the communicating section 64 receives vehicle parameters transmitted from the in-vehicle control apparatus 18, supplies, to the video transformation processing section 73, the position/posture data regarding an occupant in the vehicle 13 included in the vehicle parameters, and supplies, to the virtual space generating section 71, the driving operation data included in the vehicle parameters. In addition, the communicating section 64 transmits, to the vehicle 13, vehicle setting parameters supplied from the virtual space generating section 71 and a vehicle-13 video/audio stream supplied from the signal multiplexing section 72.

The virtual space storage section 65 stores virtual space data including the shapes and textures of roads, buildings, and the like included in the virtual space where the vehicle 13 travels virtually in driving simulation.

The 3DCG storage section 66 stores 3DCG (3-Dimensional Computer Graphics) data including the shapes and textures representing various types of three-dimensional objects (e.g., other vehicles, pedestrians, traffic lights, etc.) to be arranged in the virtual space where the vehicle 13 travels virtually in driving simulation.

The 3DCG generating section 67 reads out, from the 3DCG storage section 66, the 3DCG data of objects to be arranged near the vehicle 13 in driving simulation, generates the objects, and supplies the objects to the virtual space generating section 71.

The object audio storage section 68 stores audio data representing audio (e.g., traveling sounds of other vehicles, footsteps of pedestrians, melodies of traffic lights, etc.) emitted from various types of three-dimensional objects to be arranged in the virtual space where the vehicle 13 travels in driving simulation.

The object audio generating section 69 reads out, from the object audio storage section 68, audio data corresponding to objects to be arranged near the vehicle 13 in driving simulation, generates audio thereof, and supplies the audio to the virtual space generating section 71.

When a user who uses the driving simulation system 11 performs various types of operation input to the garage system control apparatus 16, the user setting acquiring section 70 acquires and stores user-set values according to the user operation input, and supplies the user-set values to the virtual space generating section 71. For example, when operation input for giving an instruction to start driving simulation is performed, the user setting acquiring section 70 acquires and stores a user-set value for giving the instruction to start driving simulation, and supplies the user-set value to the virtual space generating section 71.

The virtual space generating section 71 generates the virtual space by reading out the virtual space data from the virtual space storage section 65, arranges, in the virtual space, the objects supplied from the 3DCG generating section 67, and sets the sound source of the audio supplied from the object audio generating section 69, in association with the positions of the respective objects.

Then, the virtual space generating section 71 performs driving simulation of virtual traveling of the vehicle 13 in the virtual space according to the driving operation data supplied from the communicating section 64. As a result, the virtual space generating section 71 determines a behavior of the vehicle 13 in the virtual space, generates vehicle setting parameters (suspension setting data, seat setting data, and reaction force setting data) for controlling the behavior of the vehicle 13 in such a manner as to reproduce the behavior, and supplies the vehicle setting parameters to the communicating section 64.

Further, the virtual space generating section 71 generates a vehicle-13 video stream, a vehicle-13 audio stream, and a garage video stream according to the traveling position of the vehicle 13 based on the driving operation data.

For example, the virtual space generating section 71 generates a vehicle-13 video stream corresponding to the navigation video displayed on the navigation display 51 in such a manner that a vehicle mark representing the traveling position of the vehicle 13 is arranged on a map image of the virtual space and the vehicle mark moves on the map image according to the driving operation data. In addition, the virtual space generating section 71 generates a vehicle-13 video stream corresponding to the side mirror videos displayed on the side mirror displays 52L and 52R by arranging virtual cameras in the virtual space in such a manner that the virtual cameras correspond to the side mirror cameras installed on the left side and right side of the vehicle 13, and capturing images of the virtual space by the respective virtual cameras. In addition, the virtual space generating section 71 generates a vehicle-13 video stream corresponding to the instrument panel video displayed on the instrument panel display 53, according to various types of instrument data such as a traveling speed and an engine revolution speed based on the driving operation data.

In addition, the virtual space generating section 71 generates a vehicle-13 video stream to be a rearview mirror video displayed on the rearview mirror display 54, by arranging a virtual camera in the virtual space such that the virtual camera corresponds to the rearview mirror camera installed on the rear side of the vehicle 13 and capturing images of the virtual space by the virtual camera. In addition, the virtual space generating section 71 generates a vehicle-13 video stream to be the rear seat viewpoint videos displayed on the rear seat displays 55L and 55R, by arranging virtual cameras in the virtual space such that the virtual cameras correspond to the viewpoints of occupants of the rear seats and capturing, by the virtual cameras, images of the virtual space to be seen ahead of the rear seat displays 55L and 55R. Then, the virtual space generating section 71 supplies the thus-generated vehicle-13 video streams to the signal multiplexing section 72.

In addition, the virtual space generating section 71 generates a vehicle-13 audio stream such that object audio is emitted from objects to be arranged near the vehicle 13 that travels in the virtual space according to the driving operation data, with the positions of the respective objects being the sound source positions of audio, and supplies the vehicle-13 audio stream to the video transformation processing section 73.

In addition, the virtual space generating section 71 generates a garage video stream by arranging a virtual camera in the virtual space such that the virtual camera corresponds to a predetermined position of the vehicle 13 (e.g., the center position of the vehicle 13) and capturing images of the virtual space in all directions by the virtual camera with the vehicle 13 as the center, and supplies the garage video stream to the video transformation processing section 73.

The signal multiplexing section 72 generates a vehicle-13 video/audio stream by multiplexing the vehicle-13 video streams and the vehicle-13 audio stream supplied from the virtual space generating section 71, and supplies the vehicle-13 video/audio stream to the communicating section 64.

The video transformation processing section 73 implements a video transformation process on the garage video stream supplied from the virtual space generating section 71, the video transformation process being based on the position/posture data regarding the vehicle 13 supplied from the vehicle position/posture recognizing section 63 and the position/posture data regarding occupants in the vehicle 13 supplied from the communicating section 64. For example, the video transformation processing section 73 has a viewpoint sensing section 81 and a geometric transforming section 82.

As described above with reference to FIG. 5, on the basis of the position/posture data regarding the vehicle 13, the viewpoint sensing section 81 sets the cuboid space C in which the vehicle 13 is inscribed, at the position of the vehicle 13 relative to the garage displays 41. Then, by setting the positions/postures and viewpoints/lines of sight of occupants based on the position/posture data regarding the occupants in the vehicle 13 in the cuboid space C, the viewpoint sensing section 81 can determine the positions/postures and viewpoints/lines of sight of the occupants relative to the garage displays 41. As a result, the viewpoint sensing section 81 can supply, to geometric transforming section 82, information regarding the viewpoints and lines of sight of the occupants relative to the garage displays 41.

On the basis of the positions of the respective garage displays 41 and the viewpoints and lines of sight of the occupants relative to the garage displays 41, the geometric transforming section 82 implements geometric transformation on the garage video stream supplied from the virtual space generating section 71. That is, the geometric transforming section 82 implements, on the garage video stream, such geometric transformation that the garage video stream is projected onto the respective garage displays 41 as projection planes with the viewpoints and lines of sight of the occupants specified by the viewpoint sensing section 81 as the reference viewpoints and lines of sight, and generates a video stream for each garage display 41. As a result, for example, a planar ceiling side video stream is generated by projecting a spherical garage video stream with the vehicle 13 at its center onto the ceiling side garage display 41-1. Similarly, a planar video stream is generated also for each of the other garage displays 41.

For example, as depicted in FIG. 7, in a case where it is desired to express, with use of the garage displays 41, a virtual plane seen from the viewpoint position P, straight lines equivalent to rays passing through points on a virtual plane that is desired to be expressed are drawn from the viewpoint position P, and the intersections of the straight lines passing through the respective points on the virtual plane on the garage displays 41 are perspective projection points. Accordingly, pixels of the garage displays 41 can be identified. At this time, because the viewpoint position P and the positions of the garage displays 41 are determined by computation, the respective positions/postures need to be strictly quantified using coordinate values or the like in a shared coordinate system or the like. For example, these processes can easily generate videos that should be displayed on the arranged garage displays 41 relative to the positions/postures of cameras that capture images, by using a mechanism having already been realized using a game engine.

The ceiling side video transmitting section 74 transmits, to the ceiling side garage display 41-1, the ceiling side video stream supplied from the video transformation processing section 73, and causes the ceiling side garage display 41-1 to display the ceiling side simulation video.

The front side video transmitting section 75 transmits, to the front side garage display 41-2, a front side video stream supplied from the video transformation processing section 73, and causes the front side garage display 41-2 to display the front side simulation video.

The right side video transmitting section 76 transmits, to the right side garage display 41-3, a right side video stream supplied from the video transformation processing section 73, and causes the right side garage display 41-3 to display the right side simulation video.

The left side video transmitting section 77 transmits, to the left side garage display 41-4, a left side video stream supplied from the video transformation processing section 73, and causes the left side garage display 41-4 to display the left side simulation video.

The rear side video transmitting section 78 transmits, to the rear side garage display 41-5, a rear side video stream supplied from the video transformation processing section 73, and causes the rear side garage display 41-5 to display the rear side simulation video.

The floor side video transmitting section 79 transmits, to the floor side garage display 41-6, a floor side video stream supplied from the video transformation processing section 73, and causes the floor side garage display 41-6 to display the floor side simulation video.

### <Configuration Example of In-vehicle Control Apparatus>

A configuration example of the in-vehicle control apparatus 18 is explained with reference to FIG. 8 and FIG. 9.

FIG. 8 is a block diagram depicting a configuration example of operation systems and drive systems of the in-vehicle control apparatus 18.

As depicted in FIG. 8, the in-vehicle control apparatus 18 includes a sensor data acquiring section 91, a video data acquiring section 92, a sensor data acquiring section 93, a video data acquiring section 94, a vehicle internal environment recognizing section 95, a vehicle external environment recognizing section 96, a communicating section 97, a user setting acquiring section 98, a stopped state deciding section 99, a brake position data acquiring section 100, a steering wheel rotation data acquiring section 101, an accelerator position data acquiring section 102, a driving operation sensing section 103, a travel mode control section 104, a simulation mode control section 105, an axial-direction control section 106, a throttle control section 107, a brake control section 108, a steering wheel reaction force control section 109, a suspension control section 110, a brake reaction force control section 111, an accelerator reaction force control section 112, and a seat control section 113.

The sensor data acquiring section 91 acquires the sensor data supplied from the in-vehicle sensors 57, and supplies the sensor data to the vehicle internal environment recognizing section 95.

The video data acquiring section 92 acquires the video data supplied from the in-vehicle camera 56, and supplies the video data to the vehicle internal environment recognizing section 95.

The sensor data acquiring section 93 acquires sensor data supplied from an outside-vehicle sensor (not depicted) provided outside the vehicle 13, and supplies the sensor data to the vehicle external environment recognizing section 96.

The video data acquiring section 94 acquires video data supplied from an outside-vehicle camera (not depicted) provided outside the vehicle 13, and supplies the video data to the vehicle external environment recognizing section 96.

The vehicle internal environment recognizing section 95 generates the position/posture data regarding occupants in the vehicle 13 on the basis of the sensor data supplied from the sensor data acquiring section 91 and the video data supplied from the video data acquiring section 92, and supplies the position/posture data to the communicating section 97. For example, as explained with reference to FIG. 5 described above, the position/posture data regarding occupants in the vehicle 13 includes information representing the viewpoint positions and line-of-sight directions of the occupants in the vehicle 13 relative to the cuboid space C in which the vehicle 13 is inscribed.

On the basis of the sensor data supplied from the sensor data acquiring section 93 and the video data supplied from the video data acquiring section 94, the vehicle external environment recognizing section 96 generates vehicle external environment data, and supplies the vehicle external environment data to the stopped state deciding section 99 and the travel mode control section 104. For example, the vehicle external environment data includes information representing the distances to objects around the vehicle 13, and includes, in a case where the vehicle 13 is garaged in the garage apparatus 14, information representing the distances to the garage displays 41.

The communicating section 97 communicates with the garage system control apparatus 16 and an external network. For example, the communicating section 97 transmits, to the garage system control apparatus 16, a stopped state notification supplied from the stopped state deciding section 99, receives a garage state notification transmitted from the garage system control apparatus 16, and supplies the garage state notification to the stopped state deciding section 99. In addition, the communicating section 97 transmits, to the garage system control apparatus 16, vehicle parameters including the position/posture data regarding the occupants in the vehicle 13 supplied from the vehicle internal environment recognizing section 95 and the driving operation data supplied from the driving operation sensing section 103. Then, the communicating section 97 receives the vehicle setting parameters transmitted from the garage system control apparatus 16, and supplies the vehicle setting parameters to the simulation mode control section 105.

When a user who uses the driving simulation system 11 performs various types of operation input to the in-vehicle control apparatus 18, the user setting acquiring section 98 acquires and stores user-set values according to the operation input, and supplies the user-set values to the stopped state deciding section 99. For example, when operation input for giving an instruction to switch from the travel mode to the simulation mode is performed, the user setting acquiring section 98 acquires and stores a user-set value for giving the instruction to switch from the travel mode to the simulation mode, and supplies the user-set value to the stopped state deciding section 99.

When the user-set value for giving the instruction to switch from the travel mode to the simulation mode is supplied from the user setting acquiring section 98, the stopped state deciding section 99 decides whether or not to transition to the simulation mode, according to the vehicle external environment data supplied from the vehicle external environment recognizing section 96. In addition, the stopped state deciding section 99 transmits the stopped state notification to the garage system control apparatus 16 via the communicating section 97, and receives, via the communicating section 97, the garage state notification transmitted from the garage system control apparatus 16. In addition, the stopped state deciding section 99 supplies a stopped state signal to the travel mode control section 104 and the simulation mode control section 105.

For example, in a case where operation for giving the instruction to switch from the travel mode to the simulation mode is performed by a user when the vehicle 13 is stopped, the stopped state deciding section 99 decides to transition to the simulation mode. In addition, in a case where the vehicle 13 is stopped and the gear selector of the vehicle 13 is in the parking range, the stopped state deciding section 99 may also decide to transition to the simulation mode.

Further, for example, the stopped state deciding section 99 may also make a decision on the basis of positional information regarding the vehicle 13 using a GPS (Global Positioning System) or the like. In this case, the stopped state deciding section 99 can retain in advance positional information regarding a geographical point where driving simulation is allowed to be executed (e.g., the installation position of the garage apparatus 14), and decide to transition to the simulation mode in a case where the vehicle 13 is stopped at the geographical point where driving simulation is allowed to be executed, on the basis of the positional information regarding the vehicle 13.

In addition, for example, the stopped state deciding section 99 may also make a decision using the distances from or relative positions with respect to the garage displays 41, and, in this case, it is assumed that the garage state notification includes the distances of the vehicle 13 to the garage displays 41 or the relative positions of the vehicle 13 with respect to the garage displays 41. Further, the stopped state deciding section 99 can decide to transition to the simulation mode, in a case where the distances of the vehicle 13 to the garage displays 41 or the relative positions of the vehicle 13 with respect to the garage displays 41 are equal to or shorter than a predetermined threshold, that is, in a case where the vehicle 13 is stopped at a predetermined position in the garage apparatus 14.

In such a manner, by the stopped state deciding section 99 making a decision as to whether or not to transition to the simulation mode, it is possible to avoid a state where driving operation on the vehicle 13 is disabled at an unexpected location, for example. For example, it is possible to avoid a state where operation on the vehicle 13 is disabled suddenly, even in a case where simulation mode start operation is performed by an error when the vehicle 13 is stopped temporarily during driving.

In addition, in a case where it is not allowed to transition to the simulation mode, a message that “it is not possible to transition to the simulation mode” may be displayed on a display in the vehicle 13 on the basis of a result of the decision by the stopped state deciding section 99. At that time, a reason therefor may be displayed together. For example, examples of the reason therefor include the fact that the vehicle 13 is not stopped, the fact that the gear selector of the vehicle 13 is not in the parking range, the fact that the position of the vehicle 13 is not an appropriate location (a garage, a parking lot, a parking space, a predetermined position relative to the driving simulation system 11, etc.), and the like.

On the basis of the brake position signal supplied from the brake position sensor 29 in FIG. 2, the brake position data acquiring section 100 acquires brake position data representing the step-on amount of the brake pedal 23 according to operation by the driver of the vehicle 13, and supplies the brake position data to the driving operation sensing section 103.

On the basis of the steering wheel rotation signal supplied from the steering wheel rotation sensor 27 in FIG. 2, the steering wheel rotation data acquiring section 101 acquires steering wheel rotation data representing the rotation amount of the steering wheel 21 according to operation by the driver of the vehicle 13, and supplies the steering wheel rotation data to the driving operation sensing section 103.

On the basis of the accelerator position signal supplied from the accelerator position sensor 28 in FIG. 2, the accelerator position data acquiring section 102 acquires accelerator position data representing the step-on amount of the accelerator pedal 22 according to operation by the driver of the vehicle 13, and supplies the accelerator position data to the driving operation sensing section 103.

The driving operation sensing section 103 senses driving operation performed on the vehicle 13 by the driver, on the basis of the brake position data supplied from the brake position data acquiring section 100, the steering wheel rotation data supplied from the steering wheel rotation data acquiring section 101, and the accelerator position data supplied from the accelerator position data acquiring section 102. Then, the driving operation sensing section 103 supplies driving operation data (the brake position data, the steering wheel rotation data, and the accelerator position data) representing the content of the driving operation to the travel mode control section 104 and the communicating section 97.

In the travel mode, the travel mode control section 104 controls traveling of the vehicle 13 according to the driving operation data supplied from the driving operation sensing section 103. For example, the travel mode control section 104 generates axial-direction control data for controlling the axial direction of the tires of the vehicle 13, according to the steering wheel rotation data, and supplies the axial-direction control data to the axial-direction control section 106. In addition, the travel mode control section 104 generates throttle control data for controlling acceleration of the vehicle 13, according to the accelerator position data, and supplies the throttle control data to the throttle control section 107. In addition, the travel mode control section 104 generates brake control data for controlling deceleration of the vehicle 13, according to the brake position data, and supplies the brake control data to the brake control section 108.

Further, the travel mode control section 104 generates steering wheel reaction force control data, suspension control data, brake reaction force control data, accelerator reaction force control data, and seat control data according to the driving operation data supplied from the driving operation sensing section 103 and the vehicle external environment data supplied from the vehicle external environment recognizing section 96. Then, the travel mode control section 104 supplies the respective types of control data to the steering wheel reaction force control section 109, the suspension control section 110, the brake reaction force control section 111, the accelerator reaction force control section 112, and the seat control section 113.

In the simulation mode, the simulation mode control section 105 controls the behavior of the vehicle 13 in such a manner as to reproduce the behavior of the vehicle 13 in the virtual space, according to the vehicle setting parameters supplied from the communicating section 97.

For example, the vehicle setting parameters include the suspension setting data, the seat setting data, and the reaction force setting data (data values of the steering wheel reaction force, the brake reaction force, and the accelerator reaction force). Accordingly, according to the suspension setting data, the simulation mode control section 105 generates the suspension control data for controlling the height of each suspension of the four wheels of the vehicle 13, and supplies the suspension control data to the suspension control section 110. In addition, according to the seat setting data, the simulation mode control section 105 generates the seat control data for controlling the inclinations of the seat surface and back of a seat, and supplies the seat control data to the seat control section 113.

In addition, according to the data value of the steering wheel reaction force in the reaction force setting data, the simulation mode control section 105 generates the steering wheel reaction force control data for controlling the steering wheel reaction force to be generated at the steering wheel 21, and supplies the steering wheel reaction force control data to the steering wheel reaction force control section 109. In addition, according to the data value of the brake reaction force in the reaction force setting data, the simulation mode control section 105 generates the brake reaction force control data for controlling the brake reaction force to be generated at the brake pedal 23, and supplies the brake reaction force control data to the brake reaction force control section 111. In addition, according to the data value of the accelerator reaction force in the reaction force setting data, the simulation mode control section 105 generates the accelerator reaction force control data for controlling the accelerator reaction force to be generated at the accelerator pedal 22, and supplies the accelerator reaction force control data to the accelerator reaction force control section 112.

The axial-direction control section 106 generates the axial-direction control signal according to the axial-direction control data supplied from the travel mode control section 104, and supplies the axial-direction control signal to the axial-direction drive mechanism 30 in FIG. 3.

The throttle control section 107 generates the throttle control signal according to the throttle control data supplied from the travel mode control section 104, and supplies the throttle control signal to the throttle drive mechanism 31 in FIG. 3.

The brake control section 108 generates the brake control signal according to the brake control data supplied from the travel mode control section 104, and supplies the brake control signal to the brake drive mechanism 32 in FIG. 3.

The steering wheel reaction force control section 109 generates the steering wheel reaction force control signal according to the steering wheel reaction force control data supplied from the travel mode control section 104 or the simulation mode control section 105, and supplies the steering wheel reaction force control signal to the steering wheel reaction force drive mechanism 33 in FIG. 3.

The suspension control section 110 generates a suspension control signal according to the suspension control data supplied from the travel mode control section 104 or the simulation mode control section 105, and supplies the suspension control signal to the suspension drive mechanism 36 in FIG. 3.

The brake reaction force control section 111 generates the brake reaction force control signal according to the brake reaction force control data supplied from the travel mode control section 104 or the simulation mode control section 105, and supplies the brake reaction force control signal to the brake reaction force drive mechanism 35 in FIG. 3.

The accelerator reaction force control section 112 generates the accelerator reaction force control signal according to the accelerator reaction force control data supplied from the travel mode control section 104 or the simulation mode control section 105, and supplies the accelerator reaction force control signal to the accelerator reaction force drive mechanism 34 in FIG. 3.

The seat control section 113 generates a seat control signal according to the seat control data supplied from the travel mode control section 104 or the simulation mode control section 105, and supplies the seat control signal to the seat drive mechanism 37 in FIG. 3.

FIG. 9 depicts a block diagram depicting a configuration example of a video system and an audio system of the in-vehicle control apparatus 18.

As depicted in FIG. 9, the in-vehicle control apparatus 18 includes a user setting acquiring section 121, a communicating section 122, a video acquiring section 123, an audio acquiring section 124, a signal separating section 125, a video input switching section 126, an audio input switching section 127, a video signal processing section 128, a navigation video transmitting section 129, a side mirror video transmitting section 130, an instrument panel video transmitting section 131, a rearview mirror video transmitting section 132, a rear seat video transmitting section 133, an audio signal processing section 134, and an analog amplifying section 135.

When a user who uses the driving simulation system 11 performs various types of operation input to the in-vehicle control apparatus 18, the user setting acquiring section 121 acquires and stores user-set values according to the user operation input, and supplies the user-set values to the communicating section 122, the video input switching section 126, and the audio input switching section 127. For example, when operation input for giving the instruction to switch from the travel mode to the simulation mode is performed, the user setting acquiring section 121 acquires and stores a user-set value for giving the instruction to switch from the travel mode to the simulation mode, and supplies the user-set value to the communicating section 122, the video input switching section 126, and the audio input switching section 127.

The communicating section 122 communicates with the garage system control apparatus 16 and an external network. For example, the communicating section 122 transmits, to the garage system control apparatus 16, a user-set value that is supplied from the user setting acquiring section 121 and that is for giving the instruction to switch from the travel mode to the simulation mode. In addition, the communicating section 122 receives the vehicle-13 video/audio stream transmitted from the garage system control apparatus 16, and supplies the vehicle-13 video/audio stream to the signal separating section 125.

In the travel mode, the video acquiring section 123 acquires videos to be displayed on the navigation display 51, the side mirror displays 52L and 52R, the instrument panel display 53, the rearview mirror display 54, and the rear seat displays 55L and 55R, and supplies video streams thereof to the video input switching section 126. For example, the video acquiring section 123 acquires the navigation video according to the positional information regarding the vehicle 13, the side mirror videos captured by the side mirror cameras installed on the left side and right side of the vehicle 13, the instrument panel video based on the traveling speed, engine revolution speed, and the like of the vehicle 13, the rearview mirror video captured by the rearview mirror camera of the vehicle 13, the rear seat viewpoint videos based on a video captured by the external cameras of the vehicle 13, and the like.

In the travel mode, the audio acquiring section 124 acquires audio reproduced by the audio system mounted on the vehicle 13, and supplies an audio stream thereof to the audio input switching section 127.

The signal separating section 125 separates the vehicle-13 video/audio stream supplied from the communicating section 122 into the vehicle-13 video stream and the vehicle-13 audio stream. Then, the signal separating section 125 supplies the vehicle-13 video stream to the video input switching section 126, and supplies the vehicle-13 audio stream to the audio input switching section 127.

According to a user-set value supplied from the user setting acquiring section 121, the video input switching section 126 switches a video stream to be supplied to the video signal processing section 128. For example, in a case where a user-set value for giving the instruction to switch from the travel mode to the simulation mode is supplied, the video input switching section 126 performs switching such that the vehicle-13 video stream supplied from the signal separating section 125 is supplied to the video signal processing section 128. On the other hand, in a case where a user-set value for giving an instruction to switch from the simulation mode to the travel mode is supplied, the video input switching section 126 performs switching such that the video stream supplied from the video acquiring section 123 is supplied to the video signal processing section 128.

According to the user-set value supplied from the user setting acquiring section 121, the audio input switching section 127 switches an audio stream to be supplied to the audio signal processing section 134. For example, in a case where a user-set value for giving the instruction to switch from the travel mode to the simulation mode is supplied, the audio input switching section 127 performs switching such that the vehicle-13 audio stream supplied from the signal separating section 125 is supplied to the audio signal processing section 134. On the other hand, in a case where a user-set value for giving the instruction to switch from the simulation mode to the travel mode is supplied, the audio input switching section 127 performs switching such that the audio stream supplied from the audio acquiring section 124 is supplied to the audio signal processing section 134.

The video signal processing section 128 performs signal processing on the video stream supplied from the video input switching section 126, and acquires the navigation video stream, the side mirror video stream, the instrument panel video stream, the rearview mirror video stream, and the rear seat video stream. Then, the video signal processing section 128 supplies the navigation video stream to the navigation video transmitting section 129, supplies the side mirror video stream to the side mirror video transmitting section 130, supplies the instrument panel video stream to the instrument panel video transmitting section 131, supplies the rearview mirror video stream to the rearview mirror video transmitting section 132, and supplies the rear seat video stream to the rear seat video transmitting section 133.

The navigation video transmitting section 129 transmits, to the navigation display 51, the navigation video stream supplied from the video signal processing section 128, and causes the navigation display 51 to display the navigation video.

The side mirror video transmitting section 130 transmits, to the side mirror displays 52L and 52R, the side mirror video stream supplied from the video signal processing section 128, and causes the side mirror displays 52L and 52R to display the side mirror videos.

The instrument panel video transmitting section 131 transmits, to the instrument panel display 53, the instrument panel video stream supplied from the video signal processing section 128, and causes the instrument panel display 53 to display the instrument panel video.

The rearview mirror video transmitting section 132 transmits, to the rearview mirror display 54, the rearview mirror video stream supplied from the video signal processing section 128, and causes the rearview mirror display 54 to display the rearview mirror video.

The rear seat video transmitting section 133 transmits, to the rear seat displays 55L and 55R, the rear seat video stream supplied from the video signal processing section 128, and causes the rear seat displays 55L and 55R to display the rear seat viewpoint videos.

The audio signal processing section 134 performs signal processing on the audio stream supplied from the audio input switching section 127, acquires audio signals, and supplies the audio signals to the analog amplifying section 135.

The analog amplifying section 135 amplifies the audio signals supplied from the audio signal processing section 134, supplies the audio signals to the speakers 58-1 and 58-2, and causes the speakers 58-1 and 58-2 to output audio.

### <Example of Vehicle Parameters and Vehicle Setting Parameters>

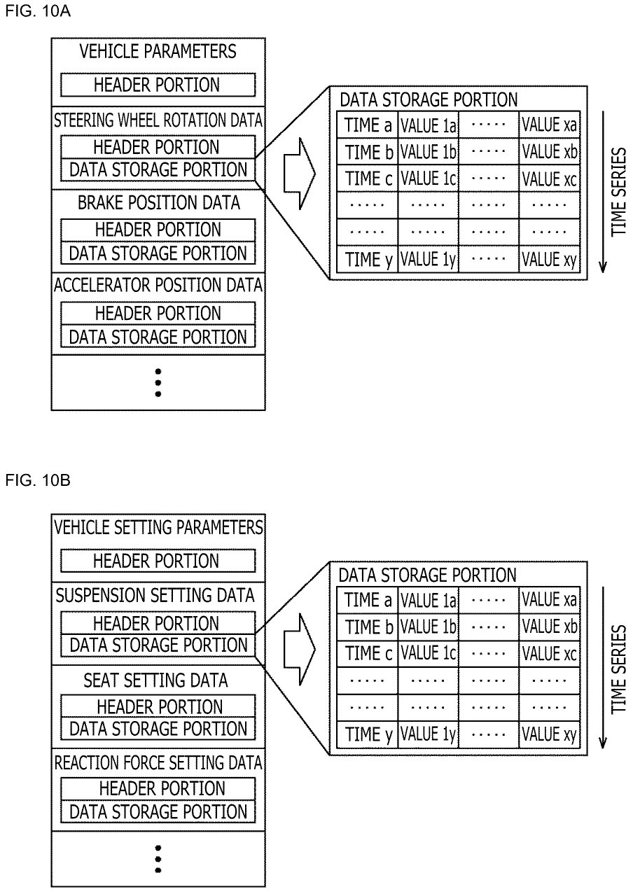

The vehicle parameters and the vehicle setting parameters are explained with reference to FIG. 10 to FIG. 14.

A of FIG. 10 depicts an example of a data structure of the vehicle parameters transmitted from the in-vehicle control apparatus 18 to the garage system control apparatus 16. B of FIG. 10 depicts an example of a data structure of the vehicle setting parameters transmitted from the garage system control apparatus 16 to the in-vehicle control apparatus 18.

As depicted in A of FIG. 10, the vehicle parameters include the steering wheel rotation data, the brake position data, the accelerator position data, and other data that are arranged in order after a header portion in which data shared by the overall vehicle parameters is stored. In addition, each of the steering wheel rotation data, the brake position data, and the accelerator position data is provided with a header portion and a data storage portion. Further, one data value or multiple data values is/are stored in association with each time in each data storage portion. In the example depicted in A of FIG. 10, x data values (e.g., a data value la to a data value xa for time a) are stored in association with each time from time a to time y.

As depicted in B of FIG. 10, the vehicle setting parameters include the suspension setting data, the seat setting data, the reaction force setting data, and other data are arranged in order after a header portion in which data shared by the overall vehicle setting parameters is stored. In addition, each of the suspension setting data, the seat setting data, and the reaction force setting data is provided with a header portion and a data storage portion. Further, one data value or multiple data values is/are stored in association with each time in each data storage portion. In the example depicted in B of FIG. 10, x data values (e.g., a data value la to a data value xa for time a) are stored in association with each time from time a to time y.

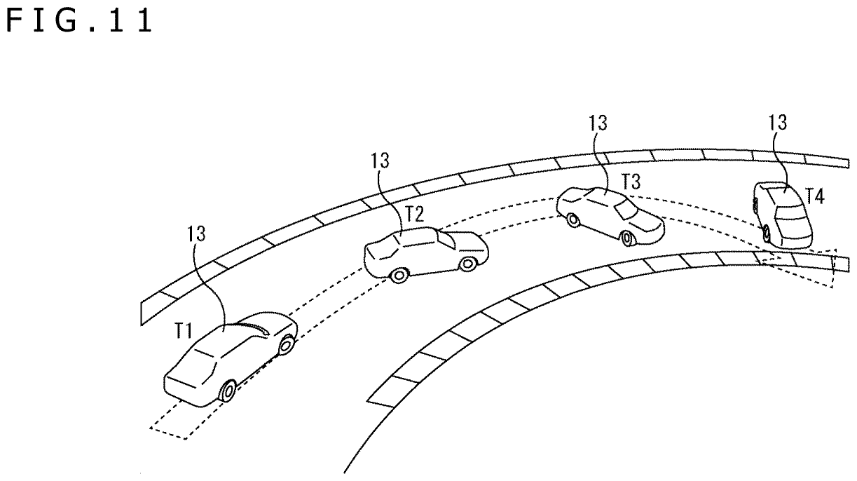

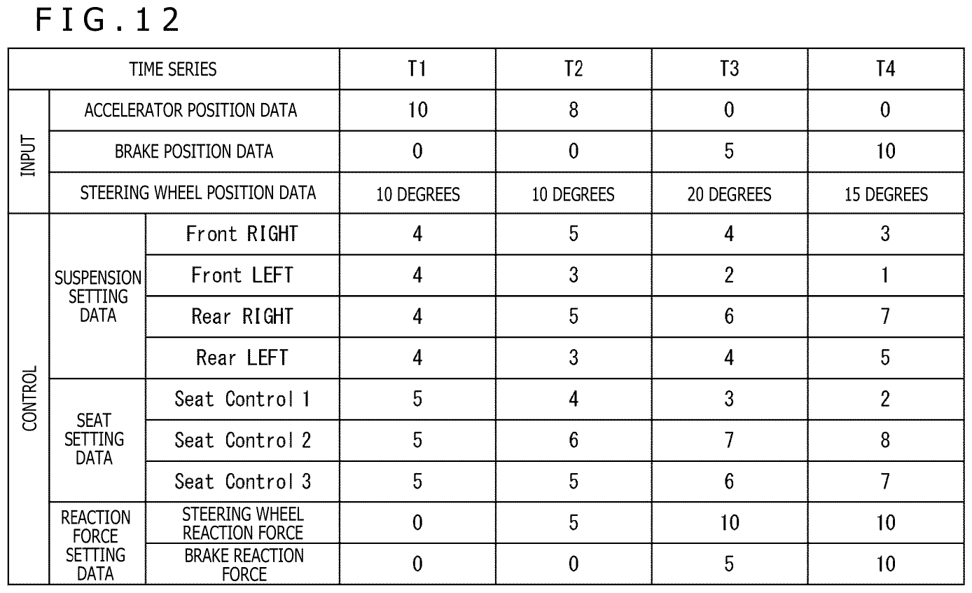

Here, an example of the vehicle parameters and the vehicle setting parameters that are generated at each time of time T1 to time T4 for the vehicle 13 that is exhibiting a spinning behavior because the steering wheel has been turned excessively as depicted in FIG. 11 is depicted in FIG. 12.

As depicted in FIG. 12, for each of the accelerator position data, the brake position data, and the steering wheel rotation data and for each time T, one data value is stored in the vehicle parameters input to the garage system control apparatus 16.

In addition, for each time T, four data values (Front RIGHT, Front LEFT, Rear RIGHT, and Rear LEFT) are stored for the suspension setting data in the vehicle setting parameters for the garage system control apparatus 16 to control the vehicle 13. Similarly, three data values (Seat Control 1, Seat Control 2, and Seat Control 3) are stored for the seat setting data, and two data values (the steering wheel reaction force and the brake reaction force) are stored for the reaction force setting data.

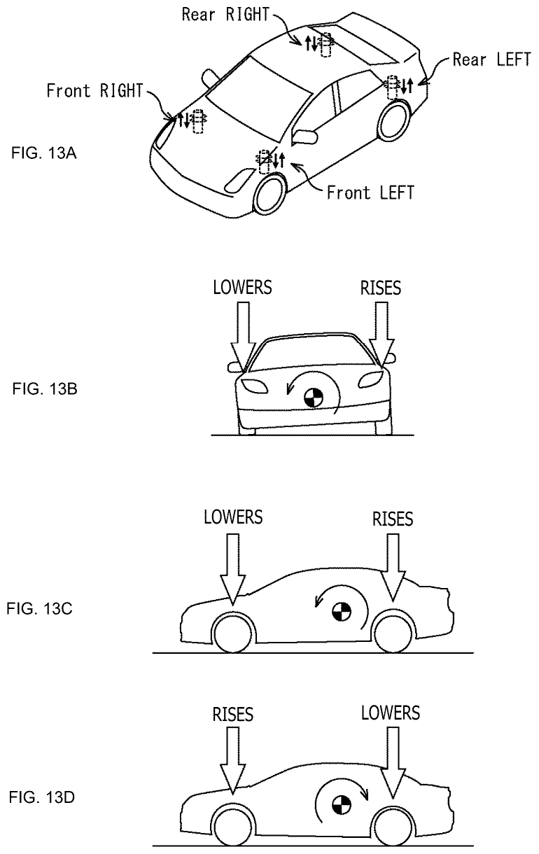

As depicted in A of FIG. 13, the data value Front RIGHT is suspension setting data for controlling the height of the suspension of the front right wheel, the data value Front LEFT is suspension setting data for controlling the height of the suspension of the front left wheel, the data value Rear RIGHT is suspension setting data for controlling the height of the suspension of the rear right wheel, and the data value Rear LEFT is suspension setting data for controlling the height of the suspension of the rear left wheel. Further, as depicted in B of FIG. 13, the suspension setting data is set such that the right suspensions lower and the left suspensions rise at the time of left cornering. In addition, as depicted in C of FIG. 13, the suspension setting data is set such that the front suspensions lower and the rear suspensions rise at the time of braking. In addition, as depicted in D of FIG. 13, the suspension setting data is set such that the rear suspensions lower and the front suspensions rise at the time of acceleration.

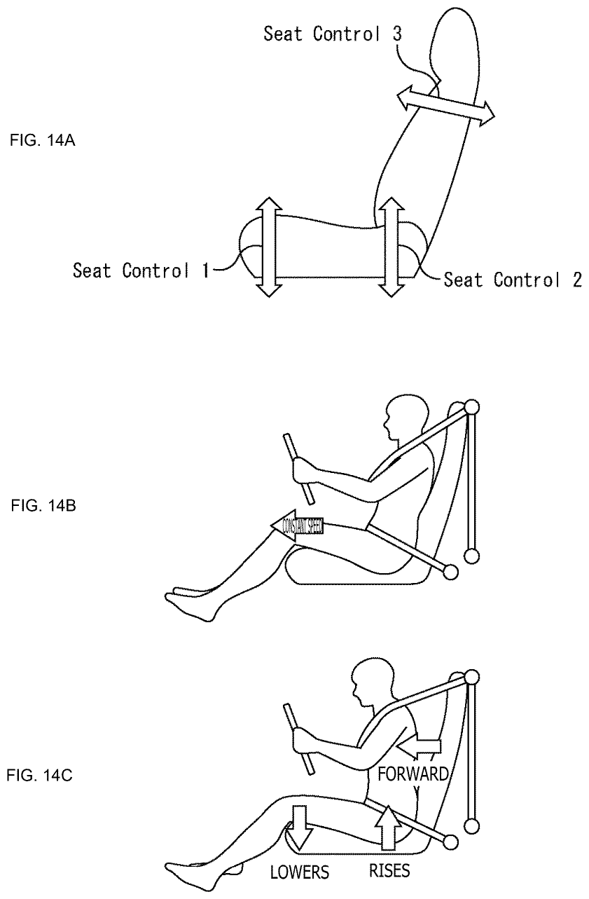

As depicted in A of FIG. 14, the data value Seat Control 1 is seat setting data for controlling the height of the front end of the seat surface, the data value Seat Control 2 is seat setting data for controlling the height of the rear end of the seat surface, and the data value Seat Control 3 is seat setting data for controlling the forward or backward inclination of the back of the seat. Further, as depicted in B of FIG. 14, the seat setting data is set such that control of the seat surface and the back of the seat is not performed at the time of constant speed traveling. In addition, as depicted in C of FIG. 14, the seat setting data is set such that the height of the front end of the seat surface lowers, the seat setting data is set such that the height of the rear end of the seat surface rises, and the seat setting data is set such that the back of the seat inclines forward at the time of braking.

### <Use Examples of Driving Simulation>

Here, first and second use examples of driving simulation are explained.

As the first use example of driving simulation, since the driving simulation system 11 can create, by using the actual vehicle 13, a state where an occupant is in the actual vehicle 13, the driving simulation system 11 can be used for learning correct drive techniques or the like under particular conditions.

For example, in a case where an occupant is caused to experience driving simulation of a situation where the road surface is extremely slippery in a situation of a heavy rain, the garage displays 41 in the garage apparatus 14 present a video imitating a landscape outside the vehicle 13.

Specifically, videos of a state of movement in a constant direction in a landscape in a case where the vehicle 13 is traveling at 40 km/h are displayed on the ceiling side garage display 41-1, the front side garage display 41-2, the right side garage display 41-3, the left side garage display 41-4, and the rear side garage display 41-5. As a result, it is possible to visually create a state as if the occupant of the vehicle 13 were traveling in the scene.

At that time, videos representing a state as if the occupant were traveling are displayed on the side mirror displays 52L and 52R and the rearview mirror display 54 equivalent to the rearview mirror and the side mirrors mounted on the vehicle 13, similarly to the garage displays 41. Then, for example, the occupant of the vehicle 13 can actually perform steering wheel operation, accelerator operation, and brake operation on the actual vehicle 13 that she/he owns, in a given scene according to instructions of driving simulation. At this time, since the vehicle 13 itself adopts the by-wire system, the actual steering system is not activated even if steering wheel operation is performed, neither brake operation nor an action performed by the piston of the brake pad does not occur, and driving operation data representing the respective operation amounts is transmitted to the garage system control apparatus 16.

According to the operation amounts obtained from the driving operation data, the garage system control apparatus 16 generates videos as if the occupant of the vehicle 13 were traveling, and causes not only the garage displays 41 but also the side mirror displays 52L and 52R and the rearview mirror display 54 mounted on the vehicle side to display the videos. At this time, the garage system control apparatus 16 configures a scene where the vehicle 13 is being driven in the virtual space, places a virtual camera in the virtual space at a position equivalent to the line of sight of the occupant, and a video captured by the virtual camera can be appropriately displayed on the garage displays 41, the side mirror displays 52L and 52R, and the rearview mirror display 54. At this time, in order to generate appropriate display videos, the position/posture data regarding the vehicle 13 relative to the positions of the garage displays 41 and the position/posture data regarding the occupant who is in the vehicle 13 relative to the positions of the garage displays 41 are necessary.

In addition, since the vehicle 13 has a suspension function that allows the heights of the four wheels to be changed independently, the heights of the four wheels can be changed according to information regarding driving simulation.

Accordingly, rolling at the time when the vehicle 13 is turning a curve, a diving action in a case where the occupant performs rapid braking, or the like can be reproduced, and, for example, a more realistic situation can be provided to the occupant by being able express a state where the vehicle 13 skids on a rainy day or another state, for example. Moreover, by providing various types of adjustment mechanisms to a seat where the occupant is seated, it becomes possible to cause the occupant to feel acceleration, by appropriately moving the seat depending on a scene and performing actions in a manner coordinated with control of the suspension height function.

At this time, it becomes possible to keep, at the garage system control apparatus 16, operation logs of various types of operation performed by the occupant, and accordingly, it is possible to analyze in detail which part of the driving technique of the occupant has problems, by analyzing the logs at a server or the like. Although such logs can also be acquired at the time of actual traveling, in that case, it is necessary to accurately perform state recognition of a scene as to what type of state the travel scene is in, and accordingly it is assumed that accurate decisions regarding the driving technique are difficult, in some cases.

In contrast to this, in the driving simulation system 11, a scene to be presented in driving simulation can be assumed in advance, and it becomes possible to acquire data as to what type of driving operation the occupant performs in the scene or in a particular state. Accordingly, more accurate decisions can be made. Needless to say, also in this case, more correct data collection can be performed by using the vehicle 13 that the occupant owns, instead of a typical driving simulator which involves use of another apparatus.

As the second use example of driving simulation, the driving simulation system 11 can be used for learning ideal driving techniques in particular scenes such as hazard avoidance.

For example, the vehicle 13 adopts the by-wire system for the steering wheel 21, the accelerator pedal 22, the brake pedal 23, and the like, and, at the same time, reaction forces can be generated to the steering wheel 21, the accelerator pedal 22, the brake pedal 23, and the like in response to respective types of operation by using actuators and the like. Accordingly, these can be effectively used for learning of driving techniques.

Specifically, in a case where operation on the steering wheel 21, the accelerator pedal 22, or the brake pedal 23 is performed in a scene, the occupant is allowed to physically experience correct steering wheel operation by, for example, application of a significant reaction force to the steering wheel 21 in a case where the occupant attempts to perform operation which deviates from teacher data representing correct driving. Similarly, by application of reaction forces also to brake operation and accelerator operation, it becomes possible to allow the occupant to physically experience correct driving operation and learn correct driving operation in the case of a heavy rain.

Also in this case, unlike typical driving simulation, the occupant can experience driving simulation using the vehicle 13 that she/he owns, and accordingly, extremely highly efficient learning of driving techniques can be expected. In addition, at this time, the teacher data is also changeable depending on the skill level of driving operation techniques of the occupant.

That is, in a case where a technique to perform hazard avoidance in a scene where road surfaces are slippery such as on a rainy day is to be learned and, as in the first use example described above, it has been decided at the time of driving simulation that the occupant is extremely skilled, it is expected that the occupant learns handling operation, braking, and accelerator operation in such a manner as to perform counter steering at the time of hazard avoidance, by physically experiencing those types of operation with respective reaction forces. On the other hand, in a case where it is decided that the occupant is relatively unskilled, it is expected that the occupant learns minimum steering wheel operation, braking, and accelerator operation by physically experiencing those types of operation with respective reaction forces.

### <Process Examples of Driving Simulation>

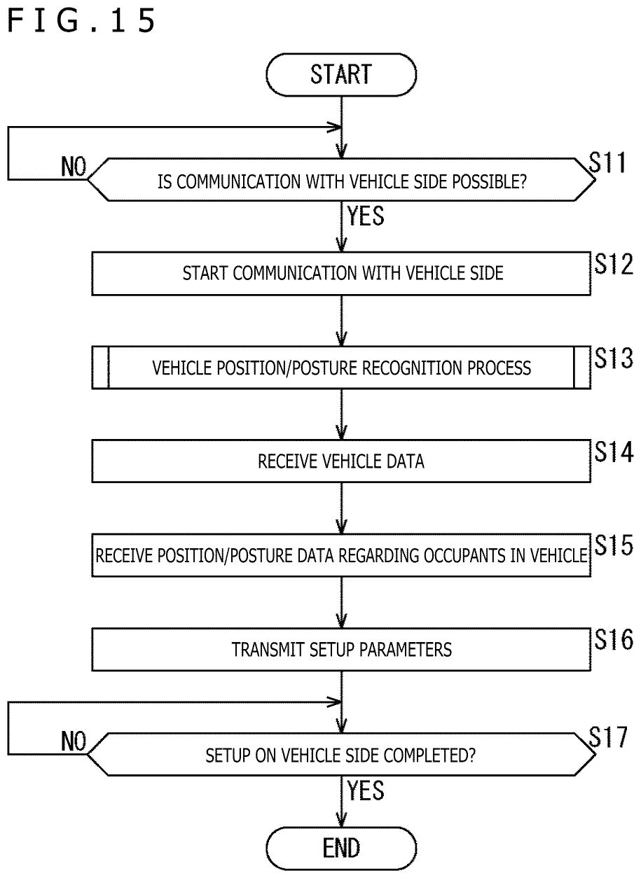

Process examples of driving simulation executed in the driving simulation system 11 are explained with reference to FIG. 15 to FIG. 21.

FIG. 15 is a flowchart for explaining an initial setup process on the side of the garage system 12.

For example, when a user performs operation input for giving the instruction to start driving simulation to the user setting acquiring section 70 of the garage system control apparatus 16, the initial setup process on the side of the garage system 12 is started.

At Step S11, the communicating section 64 of the garage system control apparatus 16 determines whether or not communication between the communicating section 97 and the communicating section 122 of the in-vehicle control apparatus 18 is possible, and waits to execute a process until it is determined that communication between the communicating section 97 and the communicating section 122 of the in-vehicle control apparatus 18 is possible. Then, in a case where the communicating section 64 determines that communication between the communicating section 97 and the communicating section 122 of the in-vehicle control apparatus 18 is possible, the process proceeds to Step S12.

At Step S12, the communicating section 64 of the garage system control apparatus 16 starts communication between the communicating section 97 and the communicating section 122 of the in-vehicle control apparatus 18.

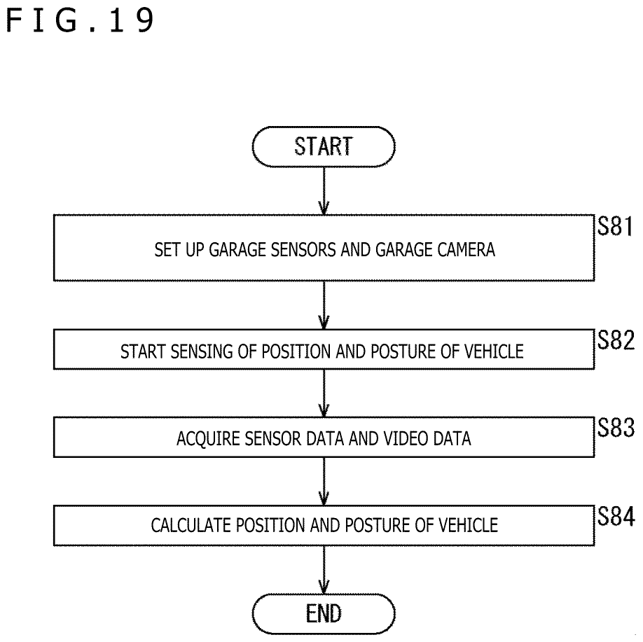

At Step S13, the vehicle position/posture recognizing section 63 of the garage system control apparatus 16 executes a vehicle position/posture recognition process (see FIG. 19) of recognizing the position and the posture of the vehicle 13, and acquires the position/posture data regarding the vehicle 13.

At Step S14, the communicating section 64 of the garage system control apparatus 16 receives vehicle data (various types of data related to the vehicle 13 that are required to execute driving simulation) transmitted from the communicating section 97 of the in-vehicle control apparatus 18, and supplies the vehicle data to the video transformation processing section 73.

At Step S15, the communicating section 64 of the garage system control apparatus 16 receives the position/posture data regarding occupants in the vehicle 13 transmitted from the communicating section 97 of the in-vehicle control apparatus 18, and supplies the position/posture data to the video transformation processing section 73.

At Step S16, the communicating section 64 of the garage system control apparatus 16 transmits, to the in-vehicle control apparatus 18, setup parameters for setting up the display system, audio system, and the like of the vehicle 13.

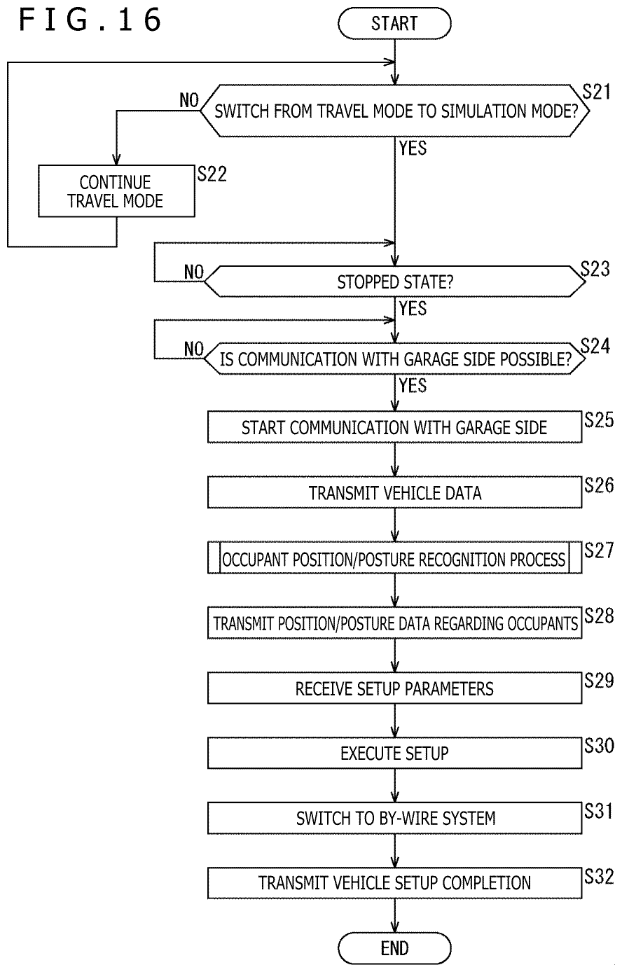

At Step S17, the communicating section 64 of the garage system control apparatus 16 determines whether or not the setup of the vehicle 13 is completed, and waits to execute a process until it is determined that the setup of the vehicle 13 is completed. For example, upon receiving a vehicle setup completion notification transmitted from the communicating section 122 of the in-vehicle control apparatus 18 at Step S32 in FIG. 16 described later, the communicating section 64 determines that the setup of the vehicle 13 is completed, and the initial setup process on the side of the garage system 12 is ended.

FIG. 16 is a flowchart for explaining an initial setup process on the side of the vehicle 13.

For example, the initial setup process on the side of the vehicle 13 is started along with activation of the in-vehicle control apparatus 18, and the vehicle 13 is set to the travel mode at this starting time point.

At Step S21, the stopped state deciding section 99 determines whether or not to switch from the travel mode to the simulation mode. For example, when the user-set value for giving the instruction to switch from the travel mode to the simulation mode is supplied from the user setting acquiring section 98, the stopped state deciding section 99 can determine to switch from the travel mode to the simulation mode.

In a case where the stopped state deciding section 99 determines at Step S21 not to switch from the travel mode to the simulation mode, the process proceeds to Step S22, and the travel mode of the vehicle 13 is continued. Subsequently, the process returns to Step S21, and a similar process is repeatedly performed thereafter.

On the other hand, in a case where the stopped state deciding section 99 determines at Step S21 to switch from the travel mode to the simulation mode, the process proceeds to Step S23.

At Step S23, the stopped state deciding section 99 determines whether or not the vehicle 13 is in the stopped state, on the basis of the vehicle external environment data supplied from the vehicle external environment recognizing section 96, and waits to execute a process until it is determined that the vehicle 13 is in the stopped state. Then, in a case where the stopped state deciding section 99 determines that the vehicle 13 is in the stopped state, the process proceeds to Step S24.

At Step S24, the communicating section 97 and the communicating section 122 of the in-vehicle control apparatus 18 determine whether or not communication with the communicating section 64 of the garage system control apparatus 16 is possible, and wait to execute a process until it is determined that communication with the communicating section 64 of the garage system control apparatus 16 is possible. Then, in a case where the communicating section 97 and the communicating section 122 determine that communication with the communicating section 64 of the garage system control apparatus 16 is possible, the process proceeds to Step S25.

At Step S25, the communicating section 97 and the communicating section 122 of the in-vehicle control apparatus 18 start communication with the communicating section 64 of the garage system control apparatus 16.

At Step S26, the communicating section 97 of the in-vehicle control apparatus 18 transmits the vehicle data to the communicating section 97 of the in-vehicle control apparatus 18.

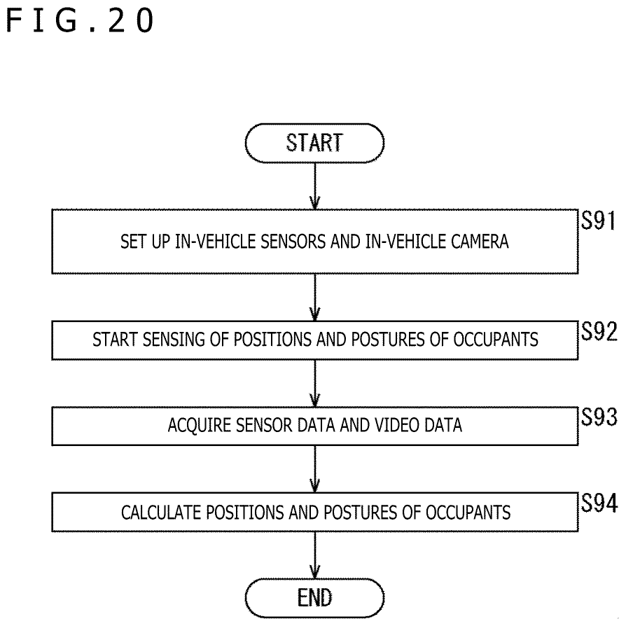

At Step S27, the vehicle internal environment recognizing section 95 executes an occupant position/posture recognition process (see FIG. 20) of recognizing the position and the posture of occupants in the vehicle 13, and acquires the position/posture data regarding the occupants in the vehicle 13.

At Step S28, the vehicle internal environment recognizing section 95 supplies, to the communicating section 97, the position/posture data regarding the occupants in the vehicle 13 acquired by the occupant position/posture recognition process at Step S27, and the communicating section 97 transmits the position/posture data regarding the occupants in the vehicle 13 to the garage system control apparatus 16.

At Step S29, the communicating section 122 of the in-vehicle control apparatus 18 receives the setup parameters transmitted from the garage system control apparatus 16 at Step S16 in FIG. 15.

At Step S30, the communicating section 122 of the in-vehicle control apparatus 18 supplies the setup parameters received at Step S29 to the display system, audio system, and the like of the vehicle 13, and causes setup of the display system, audio system, and the like to be executed.

At Step S31, switching to the by-wire system is performed, and transition from control by the travel mode control section 104 to control by the simulation mode control section 105 is made.

At Step S32, the communicating section 97 and the communicating section 122 of the in-vehicle control apparatus 18 transmit, to the garage system control apparatus 16, the vehicle setup completion notification to notify the garage system control apparatus 16 of completion of the setup of the vehicle 13, and the initial setup process on the side of the vehicle 13 is ended.

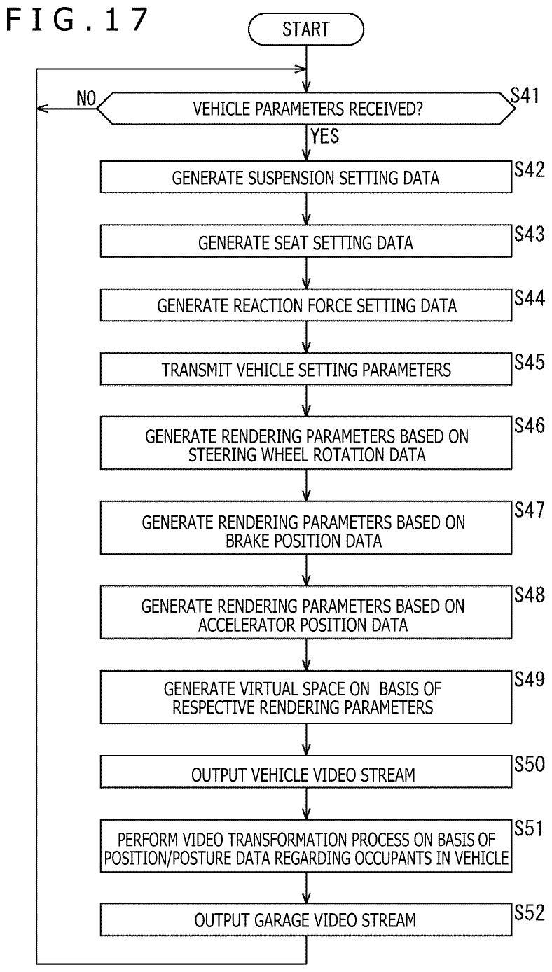

FIG. 17 is a flowchart for explaining a driving simulation action process on the side of the garage system 12.

For example, when the initial setup process on the side of the garage system 12 in FIG. 15 ends, the driving simulation action process on the side of the garage system 12 is started.

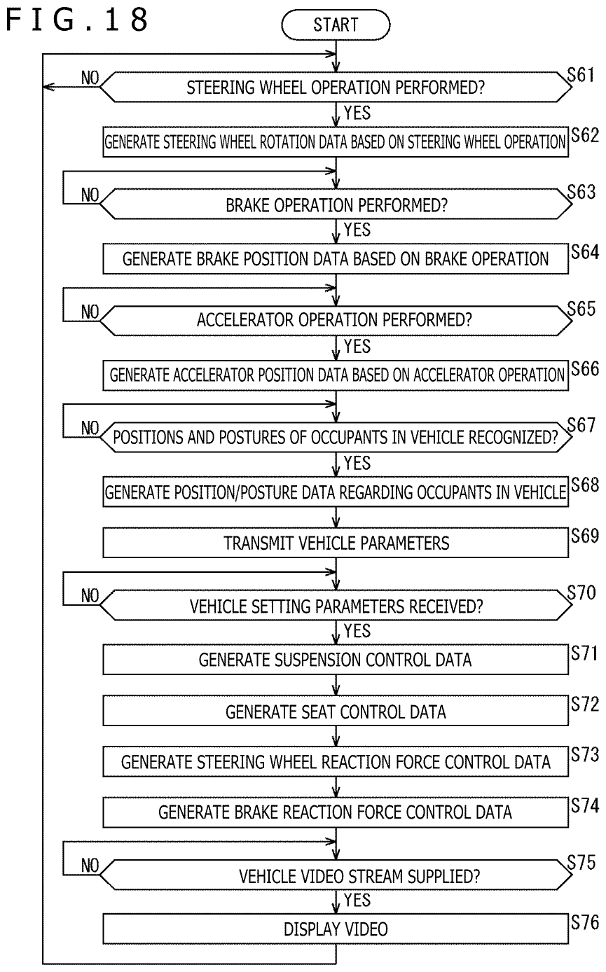

At Step S41, the communicating section 64 of the garage system control apparatus 16 determines whether or not the vehicle parameters are received, and waits to execute a process until it is determined that the vehicle parameters are received. For example, upon receiving the vehicle parameters transmitted from the communicating section 97 of the in-vehicle control apparatus 18 at Step S69 in FIG. 18 described later, the communicating section 64 supplies, to the virtual space generating section 71, the driving operation data included in the vehicle parameters, and supplies, to the video transformation processing section 73, the position/posture data regarding the occupants in the vehicle 13 included in the vehicle parameters. Then, the communicating section 64 determines that the vehicle parameters are received, and the process proceeds to Step S42.

At Step S42, the virtual space generating section 71 generates the suspension setting data as explained with reference to FIG. 13 described above, on the basis of a behavior (cornering, acceleration, deceleration, etc.) of the vehicle 13 determined in driving simulation according to the driving operation data supplied at Step S41.

At Step S43, the virtual space generating section 71 generates the seat setting data as explained with reference to FIG. 14 described above, on the basis of a behavior (at the time of constant speed traveling, at the time of braking, etc.) of the vehicle 13 determined in driving simulation according to the driving operation data supplied at Step S41.

At Step S44, the virtual space generating section 71 determines the steering wheel reaction force to be generated at the steering wheel 21, the accelerator reaction force to be generated at the accelerator pedal 22, and the brake reaction force to be generated at the brake pedal 23, on the basis of a behavior of the vehicle 13 determined in driving simulation according to the driving operation data supplied at Step S41.

Then, the virtual space generating section 71 generates the reaction force setting data in which the steering wheel reaction force, the accelerator reaction force, and the brake reaction force are stored.

At Step S45, the virtual space generating section 71 supplies, to the communicating section 64, the vehicle setting parameters including the suspension setting data generated at Step S42, the seat setting data generated at Step S43, and the reaction force setting data generated at Step S44. Then, the communicating section 64 transmits the vehicle setting parameters to the in-vehicle control apparatus 18.

At Step S46, the virtual space generating section 71 generates rendering parameters based on the steering wheel rotation data included in the driving operation data supplied from the communicating section 64 at Step S41.

At Step S47, the virtual space generating section 71 generates rendering parameters based on the brake position data included in the driving operation data supplied from the communicating section 64 at Step S41.

At Step S48, the virtual space generating section 71 generates rendering parameters based on the accelerator position data included in the driving operation data supplied from the communicating section 64 at Step S41.

At Step S49, the virtual space generating section 71 arranges objects supplied from the 3DCG generating section 67, in the virtual spaced generated by reading out the virtual space data from the virtual space storage section 65. Then, the virtual space generating section 71 renders the virtual space on the basis of the respective rendering parameters generated at Steps S46 and S47, and generates the vehicle-13 video stream and the garage video stream.

At Step S50, the virtual space generating section 71 outputs, to the signal multiplexing section 72, the vehicle-13 video stream generated at Step S49. Then, the vehicle-13 video stream is transmitted to the vehicle 13 via the signal multiplexing section 72 and the communicating section 64.

At Step S51, the virtual space generating section 71 outputs, to the video transformation processing section 73, the garage video stream generated at Step S49. Then, the video transformation processing section 73 performs a video transformation process on the basis of the position/posture data regarding the vehicle 13 supplied from the vehicle position/posture recognizing section 63 and position/posture data regarding the occupants in the vehicle 13 supplied from the communicating section 64 at Step S41.

At Step S52, the video transformation processing section 73 outputs the garage video stream on which the video transformation process has been implemented at Step S51. That is, the video transformation processing section 73 supplies the ceiling side video stream to the ceiling side video transmitting section 74, and causes the ceiling side garage display 41-1 to display the ceiling side simulation video. Hereinafter, similarly, the video transformation processing section 73 causes the front side garage display 41-2 to display the front side video stream, causes the right side garage display 41-3 to display the right side simulation video, causes the left side garage display 41-4 to display the left side simulation video, causes the rear side garage display 41-5 to display the rear side simulation video, and causes the floor side garage display 41-6 to display the floor side simulation video. Subsequently, the process returns to Step S41, and a similar process is repeatedly performed thereafter.

FIG. 18 is a flowchart for explaining a driving simulation action process on the side of the vehicle 13.

For example, after the initial setup process on the side of the vehicle 13 in FIG. 16 ends, the driving simulation action process on the side of the vehicle 13 is started.

At Step S61, the steering wheel rotation data acquiring section 101 determines whether or not rotational operation on the steering wheel 21 by the driver of the vehicle 13 is performed, and waits to execute a process until it is determined that rotational operation on the steering wheel 21 by the driver of the vehicle 13 is performed. Then, in a case where the steering wheel rotation data acquiring section 101 determines at Step S61 that rotational operation on the steering wheel 21 by the driver of the vehicle 13 is performed, the process proceeds to Step S62.

At Step S62, the steering wheel rotation data acquiring section 101 acquires the steering wheel rotation data based on the rotational operation performed on the steering wheel 21 by the driver of the vehicle 13, and supplies the steering wheel rotation data to the driving operation sensing section 103.

At Step S63, the brake position data acquiring section 100 determines whether or not step-on operation on the brake pedal 23 by the driver of the vehicle 13 is performed, and waits to execute a process until it is determined that step-on operation on the brake pedal 23 by the driver of the vehicle 13 is performed. Then, in a case where the brake position data acquiring section 100 determines at Step S63 that step-on operation on the brake pedal 23 by the driver of the vehicle 13 is performed, the process proceeds to Step S64.

At Step S64, the brake position data acquiring section 100 acquires the brake position data based on the step-on operation performed on the brake pedal 23 by the driver of the vehicle 13, and supplies the brake position data to the driving operation sensing section 103.

At Step S65, the accelerator position data acquiring section 102 determines whether or not step-on operation on the accelerator pedal 22 by the driver of the vehicle 13 is performed, and waits to execute a process until it is determined that step-on operation on the accelerator pedal 22 by the driver of the vehicle 13 is performed. Then, in a case where the accelerator position data acquiring section 102 determines at Step S65 that step-on operation on the accelerator pedal 22 by the driver of the vehicle 13 is performed, the process proceeds to Step S66.

At Step S66, the accelerator position data acquiring section 102 acquires the accelerator position data based on the step-on operation performed on the accelerator pedal 22 by the driver of the vehicle 13, and supplies the accelerator position data to the driving operation sensing section 103.

At Step S67, the vehicle internal environment recognizing section 95 determines whether or not the positions and the postures of occupants in the vehicle 13 are recognized, and waits to execute a process until it is determined that the positions and the postures of the occupants in the vehicle 13 are recognized. Then, in a case where the vehicle internal environment recognizing section 95 determines at Step S67 that the positions and the postures of the occupants in the vehicle 13 are recognized, the process proceeds to Step S68.

At Step S68, the vehicle internal environment recognizing section 95 generates the position/posture data regarding the occupants in the vehicle 13.

At Step S69, the driving operation sensing section 103 supplies, to the communicating section 97, the driving operation data (the brake position data, the steering wheel rotation data, and the accelerator position data) representing the content of the driving operation by the driver of the vehicle 13. In addition, the vehicle internal environment recognizing section 95 supplies the position/posture data regarding the occupants in the vehicle 13 to the communicating section 97. Then, the communicating section 97 transmits, to the garage system control apparatus 16, the vehicle parameters including the driving operation data and the position/posture data regarding the occupants in the vehicle 13.

At Step S70, the communicating section 97 determines whether or not the vehicle setting parameters are received, and waits to execute a process until it is determined that the vehicle setting parameters are received. Then, in a case where the communicating section 64 of the garage system control apparatus 16 transmits the vehicle setting parameters at Step S45 in FIG. 17 described above, the communicating section 97 supplies the vehicle setting parameters to the simulation mode control section 105, and determines that the vehicle setting parameters are received, and the process proceeds to Step S71.

At Step S71, the simulation mode control section 105 generates the suspension control data according to the suspension setting data included in the vehicle setting parameters supplied from the communicating section 97, and supplies the suspension control data to the suspension control section 110. As a result, the suspension control section 110 can control the heights of the suspensions as explained with reference to FIG. 13, and reproduce the behavior of the vehicle 13 in the virtual space.

At Step S72, the simulation mode control section 105 generates the seat control data according to the seat setting data included in the vehicle setting parameters supplied from the communicating section 97, and supplies the seat control data to the seat control section 113. As a result, the seat control section 113 can control the seat surfaces and the inclinations of the seat surfaces as explained with reference to FIG. 14, and reproduce the behavior of the vehicle 13 in the virtual space.

At Step S73, the simulation mode control section 105 generates the steering wheel reaction force control data according to the data value of the steering wheel reaction force included in the vehicle setting parameters supplied from the communicating section 97, and supplies the steering wheel reaction force control data to the steering wheel reaction force control section 109. As a result, the steering wheel reaction force control section 109 can generate, at the steering wheel 21, the steering wheel reaction force that resists the arm strength of the driver who performs the rotational operation on the steering wheel 21, and reproduce the behavior of the vehicle 13 in the virtual space.

At Step S74, the simulation mode control section 105 generates the brake reaction force control data according to the data value of the brake reaction force included in the vehicle setting parameters supplied from the communicating section 97, and supplies the brake reaction force control data to the brake reaction force control section 111. As a result, the brake reaction force control section 111 can generate, at the brake pedal 23, the brake reaction force that resists the leg strength of the driver who performs the step-on operation on the brake pedal 23, and reproduce the behavior of the vehicle 13 in the virtual space.

At Step S75, the video signal processing section 128 determines whether or not the vehicle-13 video stream is supplied, and waits to execute a process until it is determined that the vehicle-13 video stream is supplied. Then, in a case where the vehicle-13 video stream is transmitted from the garage system control apparatus 16 at Step S50 in FIG. 17 described above, the vehicle-13 video stream is supplied to the video signal processing section 128 via the communicating section 122, the signal separating section 125, and the video input switching section 126. As a result, the video signal processing section 128 determines that the vehicle-13 video stream is supplied, and the process proceeds to Step S76.

At Step S76, the video signal processing section 128 performs signal processing on the vehicle-13 video stream, and supplies the respectively corresponding video streams to the navigation video transmitting section 129, the side mirror video transmitting section 130, the instrument panel video transmitting section 131, the rearview mirror video transmitting section 132, and the rear seat video transmitting section 133.

As a result, the respectively corresponding videos are displayed on the navigation display 51, the side mirror displays 52L and 52R, the instrument panel display 53, the rearview mirror display 54, and the rear seat displays 55L and 55R.

Subsequently, the process returns to Step S61, and the same process is repeatedly performed thereafter.

FIG. 19 is a flowchart for explaining the vehicle position/posture recognition process performed at Step S13 in FIG. 15.

At Step S81, the garage sensors 43 and the garage camera 42 are set up.

At Step S82, the garage sensors 43 and the garage camera 42 start sensing of the position and the posture of the vehicle 13, and the sensor data and the video data are output.

At Step S83, the sensor data acquiring section 61 acquires the sensor data output from the garage sensors 43, and supplies the sensor data to the vehicle position/posture recognizing section 63, and the video data acquiring section 62 acquires the video data output from the garage camera 42, and supplies the video data to the vehicle position/posture recognizing section 63.

At Step S84, the vehicle position/posture recognizing section 63 calculates the position and the posture of the vehicle 13 on the basis of the sensor data and the video data supplied at Step S83. As a result, the vehicle position/posture recognizing section 63 acquires the position/posture data regarding the vehicle 13, and the vehicle position/posture recognition process is ended.

FIG. 20 is a flowchart for explaining the occupant position/posture recognition process performed at Step S27 in FIG. 16.

At Step S91, the in-vehicle sensors 57 and the in-vehicle camera 56 are set up.

At Step S92, the in-vehicle sensors 57 and the in-vehicle camera 56 start sensing of the positions and the postures of the occupants in the vehicle 13, and the sensor data and the video data are output.

At Step S93, the sensor data acquiring section 91 acquires the sensor data output from the in-vehicle sensors 57, and supplies the sensor data to the vehicle internal environment recognizing section 95, and the video data acquiring section 92 acquires the video data output from the in-vehicle camera 56, and supplies the video data to the vehicle internal environment recognizing section 95.

At Step S94, the vehicle internal environment recognizing section 95 calculates the positions and the postures of the occupants in the vehicle 13 on the basis of the sensor data and the video data supplied at Step S93. As a result, the vehicle internal environment recognizing section 95 acquires the position/posture data regarding the occupants in the vehicle 13, and the occupant position/posture recognition process is ended.

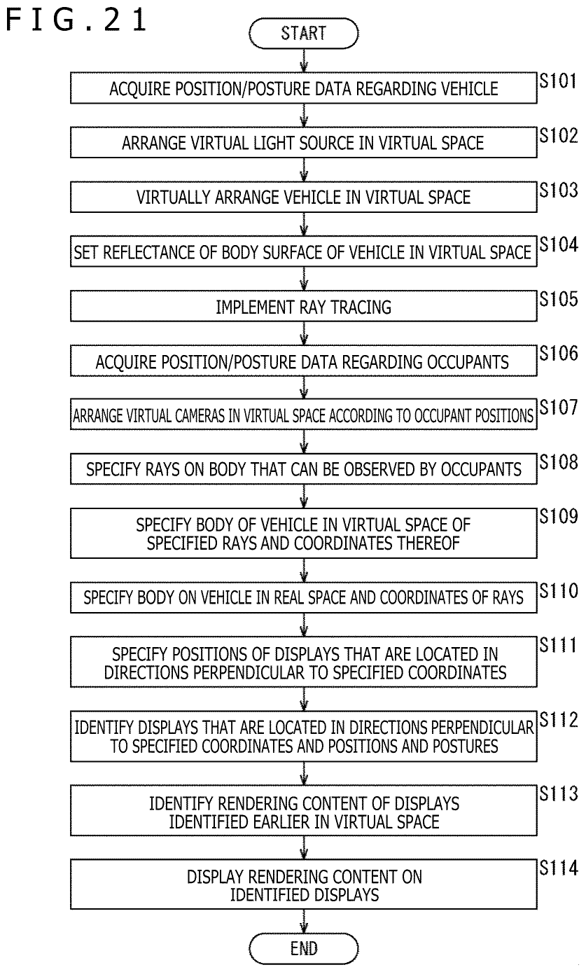

FIG. 21 is a flowchart for explaining an in-video appearance control process of controlling in-video appearance of the body of the vehicle 13.

At Step S101, the virtual space generating section 71 acquires the position/posture data regarding the vehicle 13 supplied from the vehicle position/posture recognizing section 63.

At Step S102, the virtual space generating section 71 arranges a virtual light source in the virtual space.

At Step S103, on the basis of the position/posture data acquired at Step S101, the virtual space generating section 71 arranges, in the virtual space, a 3DCG object corresponding to the vehicle 13.

At Step S104, the virtual space generating section 71 sets the reflectance of the body surface of the 3DCG object corresponding to the vehicle 13 in the virtual space.

At Step S105, the virtual space generating section 71 implements such ray tracing that the 3DCG object corresponding to the vehicle 13 arranged at Step S103 is irradiated with light from the virtual light source arranged at Step S102 and the light is reflected on the body surface at the reflectance set at Step S104.

At Step S106, the virtual space generating section 71 acquires the position/posture data regarding the occupants in the vehicle 13 supplied from the communicating section 64.

At Step S107, the virtual space generating section 71 arranges virtual cameras at positions corresponding to the viewpoint positions P of the occupants in the vehicle 13 in the virtual space.

At Step S108, from results of ray tracing using the virtual cameras arranged at Step S107, the virtual space generating section 71 specifies rays on the body of the vehicle 13 that can be observed by the occupants in the vehicle 13 in the virtual space.

At Step S109, the virtual space generating section 71 specifies the body of the vehicle 13 in the virtual space at which the rays specified at Step S108 are reflected and coordinates on the body.

At Step S110, on the basis of the sensor data supplied from the sensor data acquiring section 61 and the video data supplied from the video data acquiring section 62, the vehicle position/posture recognizing section 63 specifies, on the vehicle 13 in the real space, the body of the vehicle 13 in the virtual space and the coordinates on the body specified at Step S109.

At Step S111, the vehicle position/posture recognizing section 63 specifies the positions of garage displays 41 located in directions perpendicular to the coordinates specified at Step S110.

At Step S112, the virtual space generating section 71 identifies, in the virtual space, the positions/postures of the garage displays 41 in the real space specified at Step S111.

At Step S113, the virtual space generating section 71 identifies rendering content of the garage displays 41 identified in the virtual space at Step S112.

At Step S114, the virtual space generating section 71 causes the garage displays 41 identified at Step S112 to display the rendering content identified at Step S113, and the in-video appearance control process is ended.

By the in-video appearance control process like the one above, the shine on the surface of the body of the vehicle 13 can be reproduced.

### <Training System>

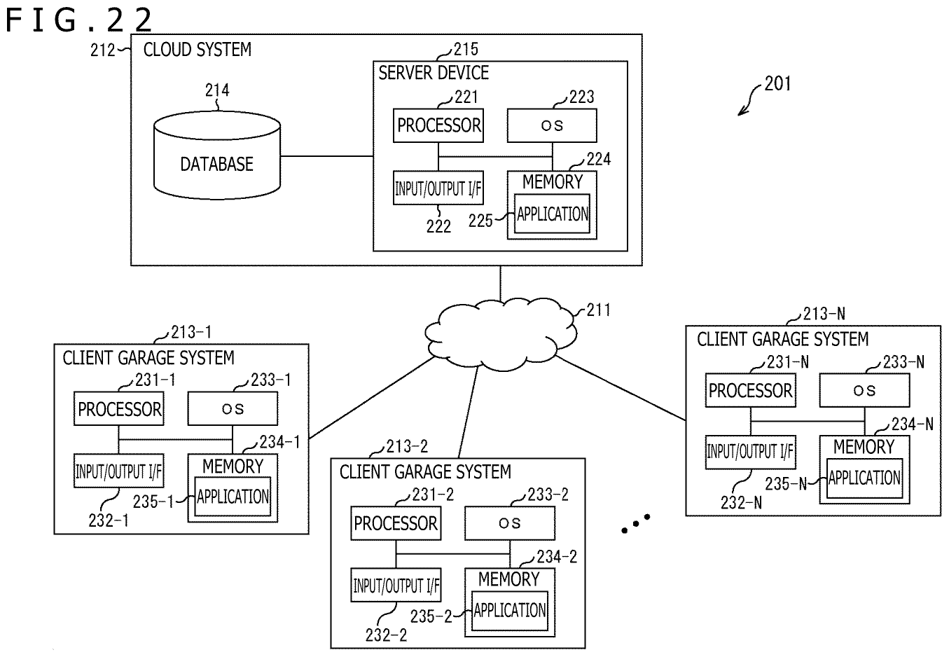

A training system using the driving simulation system 11 in FIG. 1 is explained with reference to FIG. 22 to FIG. 29.

FIG. 22 is a block diagram depicting a configuration example of the training system.

As depicted in FIG. 22, a training system 201 includes a cloud system 212 constructed on a network 211 and multiple client garage systems 213 connected to the network 211. In the example depicted in FIG. 22, N client garage systems 213-1 to 213-N are connected to the network 211. Note that, in a case where it is not necessary to make distinctions among the client garage systems 213-1 to 213-N, these are referred to as client garage systems 213 hereinbelow.

The cloud system 212 includes a database 214 and a server device 215, and the server device 215 can implement training to be provided to the multiple client garage systems 213, by using various types of data registered in the database 214.

As depicted in the figure, the server device 215 includes a processor 221, an input/output interface 222, an operating system 223, and a memory 224, and application software 225 is stored on the memory 224. Further, training is implemented by the processor 221 reading out the application software 225 from the memory 224 and executing the application software 225.

Similarly, a client garage system 213 includes a processor 231, an input/output interface 232, an operating system 233, and a memory 234, and application software 235 is stored on the memory 234. Further, training is implemented by the processor 231 reading out the application software 235 from the memory 234 and executing the application software 235. Note that the client garage system 213 corresponds to the driving simulation system 11 in FIG. 1, and includes each block included in the driving simulation system 11.

For example, the configuration of training implemented at the training system 201 is classified into unsupervised training and supervised training.

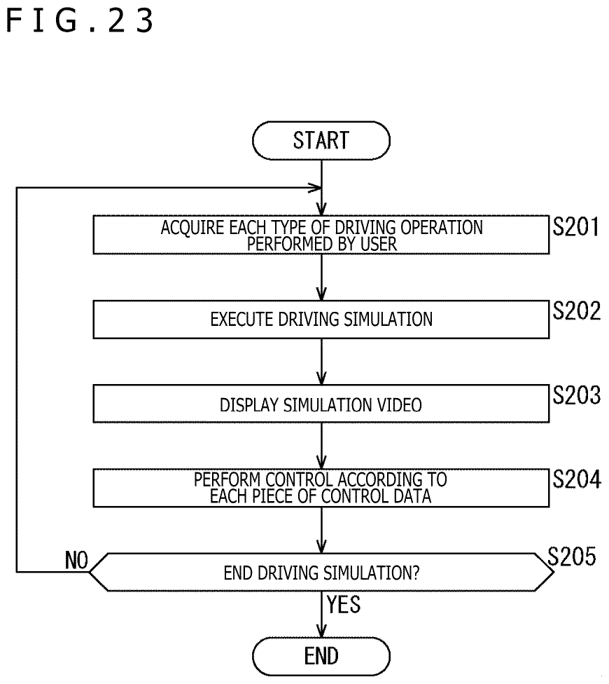

FIG. 23 is a flowchart for explaining unsupervised training.

At Step S201, a client garage system 213 acquires each type of driving operation (the steering wheel rotation data, the accelerator position data, and the brake position data) performed on the steering wheel 21, the accelerator pedal 22, and the brake pedal 23 by a user.

At Step S202, the client garage system 213 executes driving simulation (the driving simulation action processes in FIG. 17 and FIG. 18 described above) according to each type of driving operation performed by the user acquired at Step S201.

At Step S203, the client garage system 213 causes the garage displays 41 to display simulation videos generated in driving simulation executed at Step S202.

At Step S204, according to each piece of control data (the steering wheel reaction force control data, the suspension control data, the brake reaction force control data, the accelerator reaction force control data, and the seat control data) generated in the driving simulation executed at Step S202, the client garage system 213 controls respectively corresponding drive mechanisms.

At Step S205, the client garage system 213 determines whether or not to end driving simulation, for example, according to user operation input.

In a case where the client garage system 213 determines at Step S205 not to end driving simulation, the process returns to Step S201, and a similar process is repeatedly performed thereafter. In this case, the user can perform each type of driving operation while being aware of results of previous driving simulation.

On the other hand, in a case where the client garage system 213 determines to end driving simulation, unsupervised training is ended.

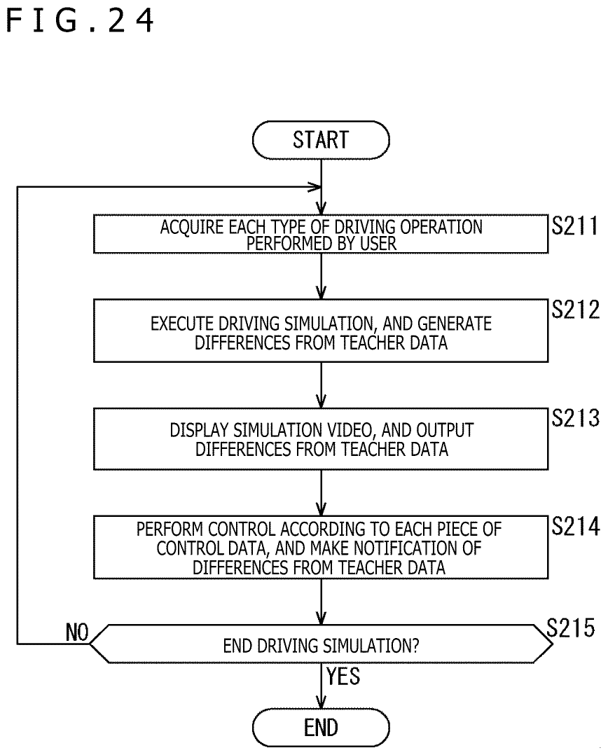

FIG. 24 is a flowchart for explaining supervised training.

At Step S211, the client garage system 213 acquires each type of driving operation performed on the steering wheel 21, the accelerator pedal 22, and the brake pedal 23 by a user.

At Step S212, the client garage system 213 executes driving simulation according to each type of driving operation performed by the user acquired at Step S211. Then, the client garage system 213 generates differences between the user operation and teacher data.

At Step S213, the client garage system 213 causes the garage displays 41 to display simulation videos generated in driving simulation executed at Step S212. At this time, the client garage system 213 outputs the differences between the user operation and the teacher data generated at Step S212.

At Step S214, according to each piece of control data generated in driving simulation executed at Step S212, the client garage system 213 controls respectively corresponding drive mechanisms. At this time, the client garage system 213 makes a notification of the differences between the user operation and the teacher data generated at Step S212.

At Step S215, the client garage system 213 determines whether or not to end driving simulation, for example, according to user operation input.

In a case where the client garage system 213 determines at Step S215 not to end driving simulation, the process returns to Step S211, and a similar process is repeatedly performed thereafter. In this case, the user can perform each type of driving operation while being aware of results of previous driving simulation.

On the other hand, in a case where the client garage system 213 determines to end driving simulation, supervised training is ended.

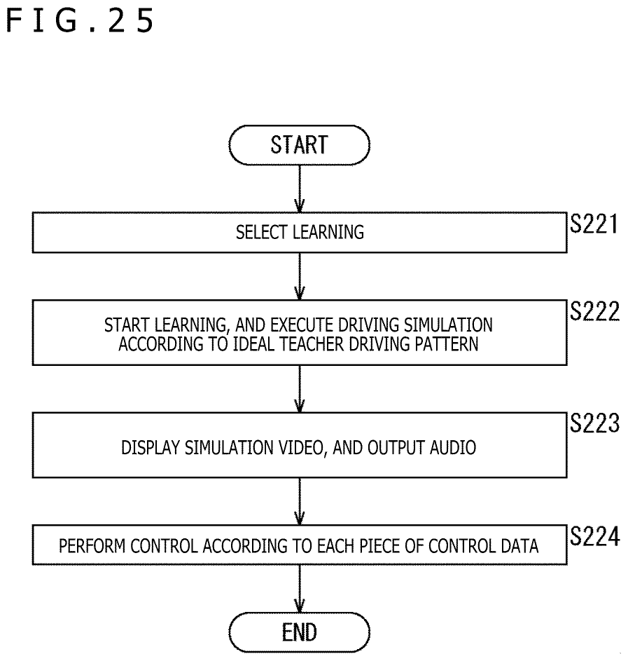

FIG. 25 is a flowchart for explaining learning.

At Step S221, the client garage system 213 selects learning according to user operation input.

At Step S222, the client garage system 213 starts learning, and executes driving simulation according to an ideal teacher driving pattern.

At Step S223, the client garage system 213 causes the garage displays 41 to display simulation videos generated in driving simulation executed at Step S222, and outputs audio generated along with the simulation videos.

At Step S224, according to each piece of control data generated in driving simulation executed at Step S222, the client garage system 213 controls respectively corresponding drive mechanisms, and then, the learning is ended.

In such learning, a student can physically experience an exemplary pattern of a teacher including AI, without performing driving operation. For example, the student can learn while physically experiencing, through applied reaction forces (operation by the teacher), an ideal driving pattern such as steering operation, braking, and accelerator operation at the driver's seat of the vehicle 13 of the student her/himself.

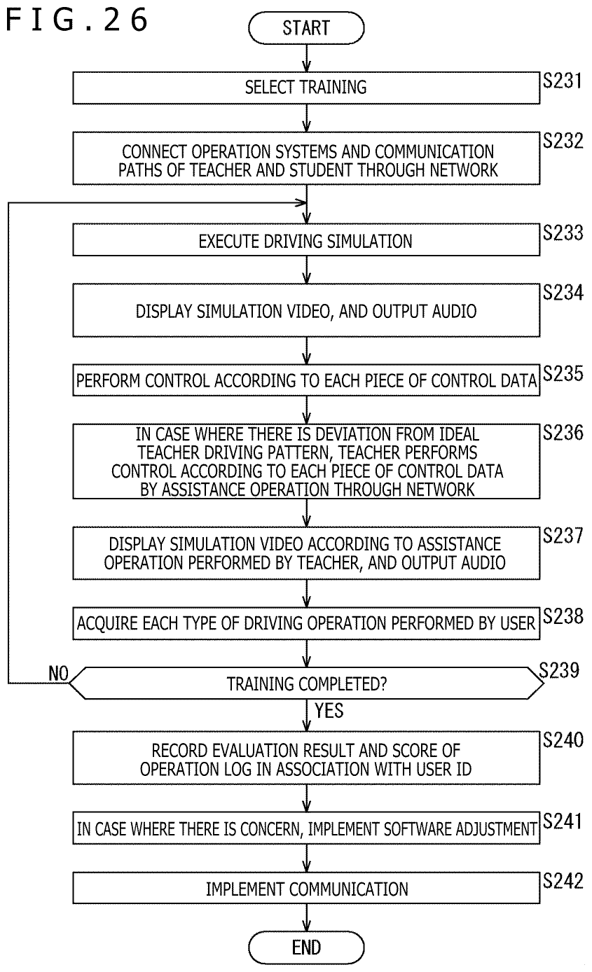

Next, at a training stage, the student performs operation, and is trained by receiving operation assistance and advice from the teacher. For example, in a case where operation by the student deviates from an ideal driving pattern, there are different optimum methods for returning to the ideal driving pattern according to situations related to courses, road surfaces, or speeds or different methods for being trained with measures for not deviating from the ideal driving pattern, as explained with reference to FIG. 26 to FIG. 28 below.

FIG. 26 is a flowchart for explaining training performed one-on-one between a human teacher and a student.

At Step S231, the client garage system 213 selects training according to operation input by the user (student).

At Step S232, the client garage system 213 connects operation systems and communication paths of the teacher and the student through the network 211.

At Step S233, the client garage system 213 executes driving simulation according to an ideal teacher driving pattern.

At Step S234, the client garage system 213 causes the garage displays 41 to display simulation videos generated in driving simulation executed at Step S233, and outputs audio generated along with the simulation videos.

At Step S235, according to each piece of control data generated in driving simulation executed at Step S233, the client garage system 213 controls respectively corresponding drive mechanisms.

At Step S236, in a case where there is a deviation from the ideal teacher driving pattern, the teacher performs assistance operation through the network 211, and, according to each piece of control data based on the assistance operation, the client garage system 213 controls respectively corresponding drive mechanisms.

At Step S237, the client garage system 213 causes the garage displays 41 to display simulation videos generated in driving simulation according to the assistance operation performed by the teacher at Step S236, and outputs audio generated along with the simulation videos.

At Step S238, the client garage system 213 acquires each type of driving operation performed on the steering wheel 21, the accelerator pedal 22, and the brake pedal 23 by the user.

At Step S239, the client garage system 213 determines whether or not the training is completed. In a case where it is determined that the training is not completed, the process returns to Step S233, and a similar process is repeatedly performed thereafter. On the other hand, in a case where the client garage system 213 determines at Step S239 that the training is completed, the process proceeds to Step S240.

At Step S240, the client garage system 213 records an evaluation result and a score of an operation log in association with a user ID.

At Step S241, in a case where there is concern, the client garage system 213 implements adjustment of software according to operation by the teacher. At this time, the teacher may also create an adjustment request to a dealer if necessary.

At Step S242, the client garage system 213 implements communication with the teacher, and then, the process is ended.

In such a manner, a human teacher and a student can perform training one-on-one using the training system 201. That is, operation systems and communication paths of the teacher and the student are connected through the network 211. Further, in a state where the student is driving, the teacher can remotely perform assistance operation and give advice regarding actions related to driving such as steering wheel operation, braking, and accelerator operation through the network 211. As a result, the user can perform training at the driver's seat of the her/his own vehicle 13 personally.

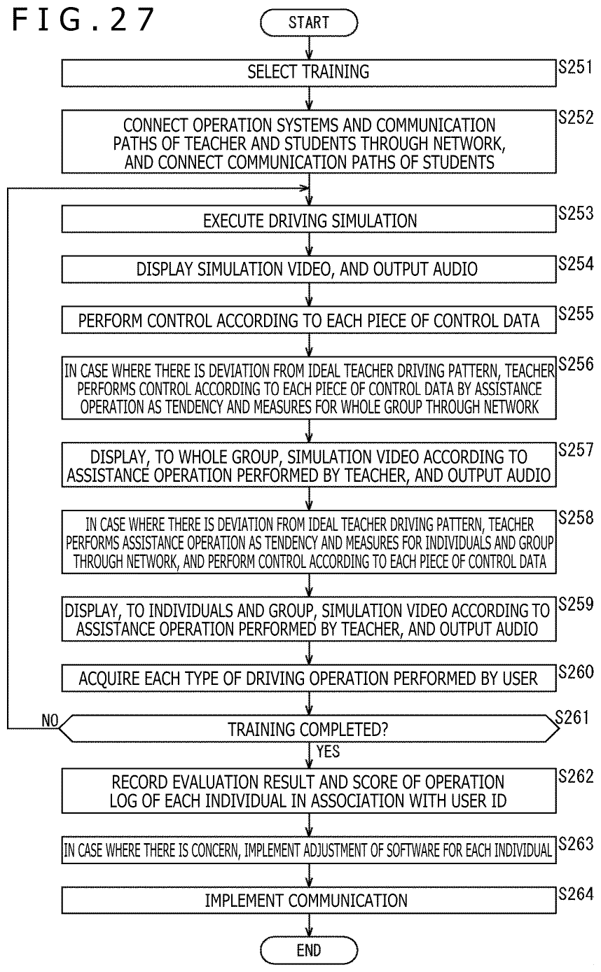

FIG. 27 is a flowchart for explaining training performed one-to-many between a human teacher and students.

At Step S251, the client garage system 213 selects training according to operation input by the users (students).

At Step S252, the client garage system 213 connects operation systems and communication paths of the teacher and the students through the network 211, and connects the communication paths of the students.

At Step S253, the client garage system 213 executes driving simulation according to an ideal teacher driving pattern.

At Step S254, the client garage system 213 causes the garage displays 41 to display simulation videos generated in driving simulation executed at Step S253, and outputs audio generated along with the simulation videos.

At Step S255, according to each piece of control data generated in driving simulation executed at Step S253, the client garage system 213 controls respectively corresponding drive mechanisms.

At Step S256, in a case where there is a deviation from the ideal teacher driving pattern, the teacher performs assistance operation as tendency and measures for the whole group through the network 211, and, according to each piece of control data based on the assistance operation, the client garage system 213 controls respectively corresponding drive mechanisms.

At Step S257, the client garage system 213 causes the garage displays 41 to display, to the whole group, simulation videos generated in driving simulation according to the assistance operation performed by the teacher at Step S256, and outputs audio generated along with the simulation videos.

At Step S258, in a case where there is a deviation from the ideal teacher driving pattern, the teacher performs assistance operation as tendency and measures for the individuals and the group through the network 211, and, according to each piece of control data based on the assistance operation, the client garage system 213 controls respectively corresponding drive mechanisms.

At Step S259, the client garage system 213 causes the garage displays 41 to display, to the individuals and the whole group, simulation videos generated in driving simulation according to the assistance operation performed by the teacher at Step S258, and outputs audio generated along with the simulation videos.

At Step S260, the client garage system 213 acquires each type of driving operation performed on the steering wheel 21, the accelerator pedal 22, and the brake pedal 23 by the users.

At Step S261, the client garage system 213 determines whether or not the training is completed. In a case where it is determined that the training is not completed, the process returns to Step S253, and a similar process is repeatedly performed thereafter. On the other hand, in a case where the client garage system 213 determines at Step S261 that the training is completed, the process proceeds to Step S262.

At Step S262, the client garage system 213 records an evaluation result and a score of an operation log of each individual in association with a user ID.

At Step S263, in a case where there is concern, the client garage system 213 implements adjustment of software for each individual according to operation by the teacher. At this time, the teacher may also create an adjustment request to a dealer if necessary. For example, the concern here includes the fact that settings of software are not appropriate for the driving skill of a user, the fact that software does not allow adjustment to settings that are suited for the driving skill of a user, and the like.

At Step S264, the client garage system 213 implements communication with the teacher and communication among the students, and then, the process is ended.

In such a manner, a human teacher and students can perform training one-to-many using the training system 201. That is, operation systems and communication paths of the teacher and a large number of the students are connected through the network 211 (the communication paths of the students may also be connected). Further, in a state where the students are driving, the teacher can remotely perform assistance operation and give advice regarding actions related to driving such as steering wheel operation, braking, and accelerator operation as tendency and measures for the whole group through the network 211. In addition, the teacher can select an individual or a group with a significant deviation from an ideal driving pattern, and can remotely perform assistance operation and give advice individually. As a result, the users can perform training at the drivers' seats of the vehicles 13 of themselves personally or with a community.

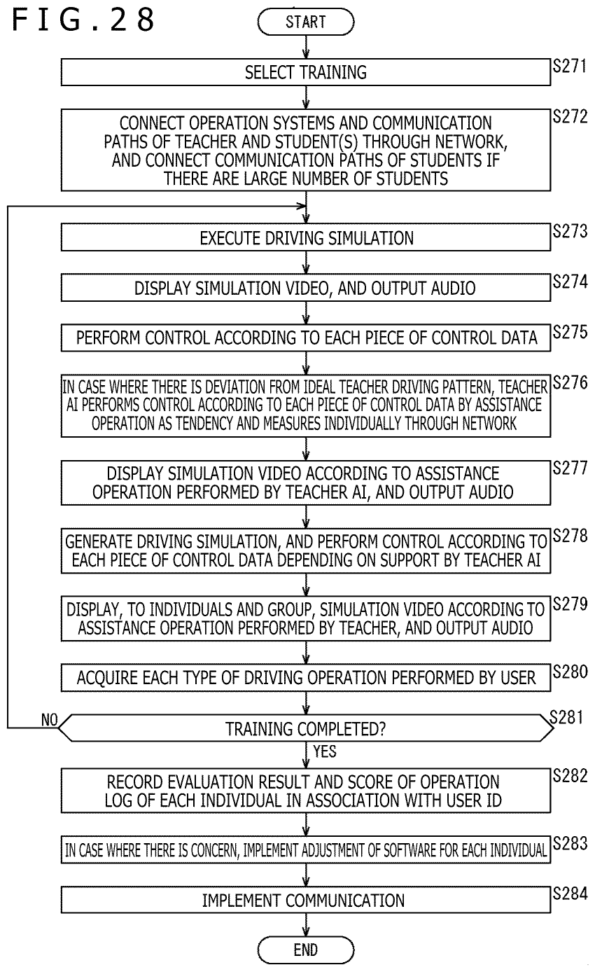

FIG. 28 is a flowchart for explaining training performed one-on-one or one-to-many between an AI teacher and a student or students.

At Step S271, the client garage system 213 selects training according to operation input by the user(s) (student(s) ).

At Step S272, the client garage system 213 connects operation systems and communication paths of the teacher AI and the student(s) through the network 211, and connects the communication paths of the students in a case where there are a large number of students.

At Step S273, the client garage system 213 executes driving simulation according to an ideal teacher driving pattern.

At Step S274, the client garage system 213 causes the garage displays 41 to display simulation videos generated in driving simulation executed at Step S273, and outputs audio generated along with the simulation videos.

At Step S275, according to each piece of control data generated in driving simulation executed at Step S273, the client garage system 213 controls respectively corresponding drive mechanisms.

At Step S276, in a case where there is a deviation from the ideal teacher driving pattern, the teacher AI performs assistance operation as tendency and measures individually through the network 211, and, according to each piece of control data based on the assistance operation, the client garage system 213 controls respectively corresponding drive mechanisms.

At Step S277, the client garage system 213 causes the garage displays 41 to display simulation videos generated in driving simulation according to the individual assistance operation performed by the teacher AI at Step S276, and outputs audio generated along with the simulation videos.

At Step S278, the client garage system 213 generates driving simulation, and, according to each piece of control data depending on support by the teacher AI, controls respectively corresponding drive mechanisms.

At Step S279, the client garage system 213 causes the garage displays 41 to display, to the individuals and the whole group, simulation videos generated in driving simulation according to the assistance operation performed by the teacher AI at Step S278, and outputs audio generated along with the simulation videos.

At Step S280, the client garage system 213 acquires each type of driving operation performed on the steering wheel 21, the accelerator pedal 22, and the brake pedal 23 by the users.

At Step S281, the client garage system 213 determines whether or not the training is completed. In a case where it is determined that the training is not completed, the process returns to Step S273, and a similar process is repeatedly performed thereafter. On the other hand, in a case where the client garage system 213 determines at Step S281 that the training is completed, the process proceeds to Step S282.

At Step S282, the client garage system 213 records an evaluation result and a score of an operation log of each individual in association with a user ID.

At Step S283, in a case where there is concern, the client garage system 213 implements adjustment of software for each individual depending on output by the teacher AI. At this time, the teacher AI may also create an adjustment request to a dealer if necessary.

At Step S284, the client garage system 213 implements communication among the students, and then, the process is ended.

In such a manner, a teacher AI and a student (students) can perform training one-on-one and one-to-many. That is, operation systems and communication paths of the teacher AI and a large number of the students are connected through the network 211 (the communication paths of the students may also be connected). Further, the teacher AI can remotely perform assistance operation and give advice regarding a deviation from an ideal driving pattern. As a result, the users can perform training at the drivers' seats of the vehicles 13 of themselves personally or with a community.

As described above, the training system 201 can make it possible to improve the efficiency of management and training itself by a combination of a human teacher and a teacher AI, such as entrusting the teacher AI repetitive training depending on the situation of training. In addition, the mode of execution of the teacher AI may be executed either on the side of the cloud system 212 or on the side of a client garage system 213.

For example, although the ideal driving pattern varies depending on the purpose such as safe driving or racing, it is assumed in the training system 201 that the ideal driving pattern is derived depending on the setting of a target goal such as training, a test, or a game element and driving by a professional, an exemplary pattern of a teacher, and various AI technologies that depend on the setting. Further, since achievement of the set target and trained behaviors are all recorded as metadata in a metaverse space in the training system 201, fair evaluation, scoring, and the like become possible. In addition, scoring can take into consideration also actions related to driving operation such as sensing of actions such as checking, by camera monitoring, of the blind spot when making a turn or sensing of operation on a shift gear, a turn signal, a hazard lamp, a fog lamp, or a defroster.

In such a manner, with use of the training system 201, it becomes possible for a user to recognize the functions and performance of a vehicle 13 of the user her/himself by performing learning and training based on actual experience using the vehicle 13, and, along with this, it becomes possible for the user to, for example, enhance the driving skill owing to enhancement of spatial awareness in driving and operation skill, for example. For example, the training system 201 can not only reduce accidents along with the enhancement of the driving skill of the user, but also contribute to licensing, license renewal, or the like since fair evaluation and scoring become possible.

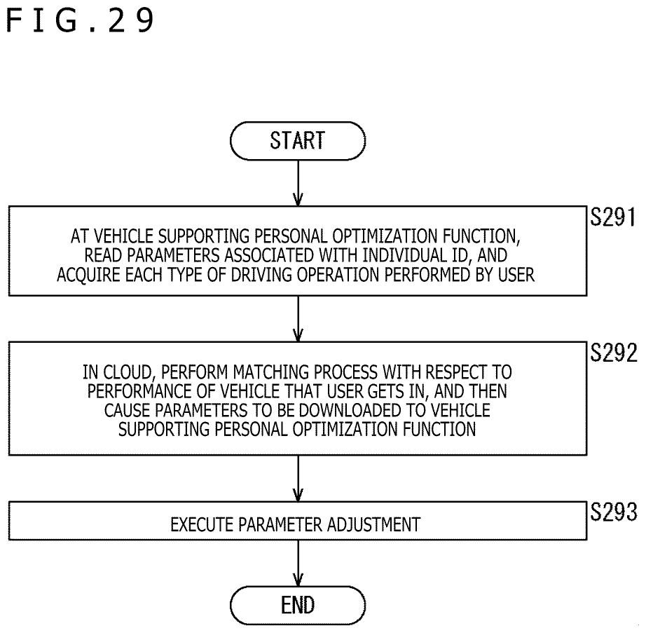

Next, personal optimization of a vehicle 13 using the training system 201 is explained with reference to FIG. 29.

For example, it is considered that, as the chassis platform of each OEM (Original Equipment Manufacturing (Manufacturer) ) is aggregated into one or two along with electrification of vehicles 13, some of the settings related to the comfort of ride and sense of operation of vehicles 13 in the future is controlled by software. Here, a method related to personal optimization of a vehicle 13 in view of the trend is explained.

For example, training allows a driver to enhance the driving skill according to the performance of her/his own vehicle 13. It is assumed that, at this time, for example, the response, weights, stiffness, and the like of the steering, brake, accelerator, suspensions, and the like impede training itself in some cases or make it impossible to perform the training at all in some other cases depending on differences in the abilities of respective individuals. In this case, a driver and a teacher can examine training response, collate the training response with data, communicate with each other, and make adjustments of software regarding partial portions that can be coped with by software control.

On the other hand, portions that cannot fully be coped with by adjustments of software can be passed onto a dealer as adjustment items to be adjusted.

At Step S291, the client garage system 213 reads parameters associated with an individual ID at a vehicle 13 supporting a personal optimization function for a user, and acquires each type of driving operation performed by the user.

At Step S292, in the cloud, the client garage system 213 performs a matching process with respect to the performance of the vehicle 13 which the user gets in, and then causes the parameters to be downloaded to the vehicle 13 supporting the personal optimization function.

At Step S293, the client garage system 213 executes parameter adjustments, and the process is ended.

The parameters personally optimized as described above can be used in the following manner.

For example, if it is possible to attempt to enhance the driving skill of a driver as a result of training and to achieve optimization through mutual compromise between the human and a vehicle as a result of adjustments on the side of the vehicle, her/his own vehicle 13 becomes the one-of-a-kind existence for the driver. On the other hand, there is a problem that it becomes difficult for the driver to drive another vehicle 13.

In view of this, adjustment parameters on the side of a vehicle associated with an ID of a driver are placed in the cloud. When the driver drives a vehicle 13 of her/his partner or when the driver drives a vehicle 13 which is a shared car, a rented car, or the like, if the vehicle 13 that the driver is about to get in supports a personal optimization function, the parameters are read from the cloud, and a matching process with respect to the performance of the vehicle 13 that the driver is about to get in is performed. As a result, the settings of the vehicle 13 can be made similar to the settings of her/his own vehicle 13 automatically.

In addition, in a case where a vehicle 13 is purchased as a replacement, training may be executed again from the beginning at the time point of purchase of the vehicle 13. However, if the vehicle 13 to be purchased as a replacement supports a personal optimization function, it is possible to make the settings of the vehicle 13 to be purchased as a replacement similar to the settings of her/his own vehicle 13 by reading, from the cloud, adjustment parameters on the side of the vehicle associated with the ID of the driver and performing a matching process with respect to the performance of the vehicle 13 to be purchased as a replacement. For example, in a case where it is possible to recognize in advance that the vehicle 13 to be purchased as a replacement supports a personal optimization function, it becomes possible to virtually reproduce, at the current vehicle 13, settings that are personally optimized after the purchase of the replacement, and to perform in advance learning or training related to the vehicle 13 to be purchased as a replacement.

Further, by making it possible to virtually experience driving of a vehicle 13 to be purchased as a replacement and learning and training thereof in a state where they are personally optimized in advance, experience that is optimum for a larger number of people can be provided, and physical test driving can be partially reduced. Accordingly, there is a possibility that an effective promotion of vehicles becomes possible, along with careful consideration for the environment and reduction of accidents.

As described above, a training system has been explained as an example of a system using the driving simulation system 11 in FIG. 1. Note that the driving simulation system 11 may also be used as a system to provide artificial driving experience. In addition, the driving simulation system 11 may also be used as a system that provides experience related to a new safety function of a vehicle 13, a safety function that is not mounted on a vehicle 13 owned by a user, and the like.

### <Configuration Example of Computer>

Next, the series of processing (information processing method) described above can also be performed by hardware and can also be performed by software. In a case where the series of processing is performed by software, a program included in the software is installed on a general-purpose computer or the like.

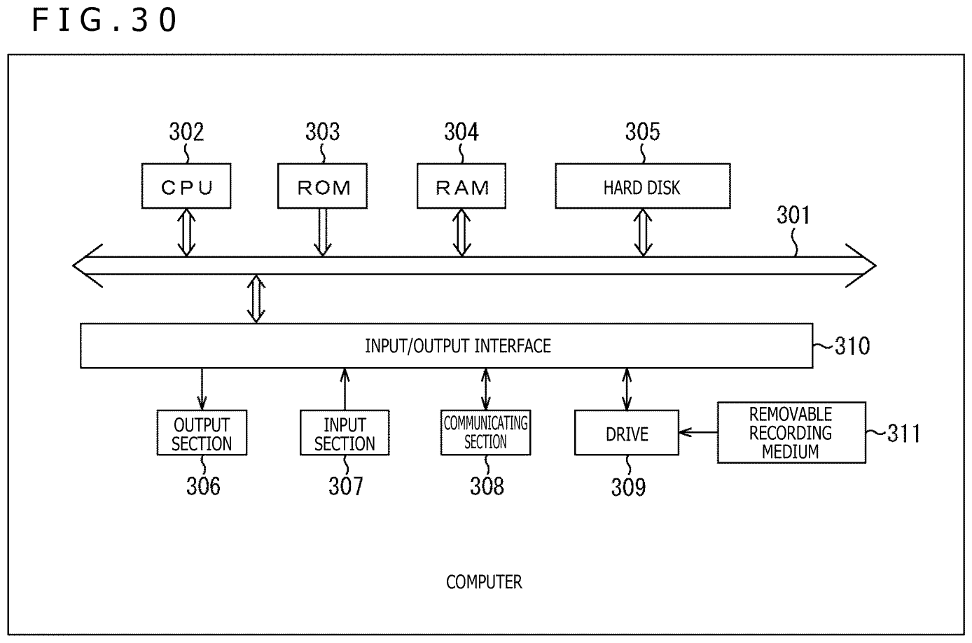

FIG. 30 is a block diagram depicting a configuration example of an embodiment of the computer on which the program that executes the series of processing described above is installed.

The program can be recorded in advance on a hard disk 305 or a ROM 303 as a recording medium built in the computer.

Alternatively, the program can be stored (recorded) on a removable recording medium 311 driven by a drive 309. Such a removable recording medium 311 can be provided as what is generally called package software. Here, for example, examples of the removable recording medium 311 include a flexible disc, a CD-ROM (Compact Disc Read Only Memory), an MO (Magneto Optical) disk, a DVD (Digital Versatile Disc), a magnetic disk, a semiconductor memory, and the like.

Note that, other than being installed on the computer from the removable recording medium 311 like the one described above, the program can be downloaded to the computer through a communication network or a broadcast network, and installed on the built-in hard disk 305. That is, for example, the program can be transferred wirelessly from a download site to the computer via an artificial satellite for digital satellite broadcasting, or transferred through cables from the download site to the computer via a network such as a LAN (Local Area Network) or the Internet.

The computer has a built-in CPU (Central Processing Unit) 302, and the CPU 302 is connected with an input/output interface 310 via a bus 301.

When a command is input via the input/output interface 310 by a user operating an input section 307, for example, the CPU 302 executes the program stored on the ROM (Read Only Memory) 303, according to the command. Alternatively, the CPU 302 loads the program stored on the hard disk 305 to a RAM (Random Access Memory) 304, and executes the program.

As a result, the CPU 302 performs processes according to the flowcharts described above or processes performed by the configurations in the block diagrams described above. Then, as necessary, the CPU 302 causes results of the processes to be output from an output section 306 via, for example, the input/output interface 310 or transmitted from a communicating section 308, to be recorded on the hard disk 305, for example.

Note that the input section 307 includes a keyboard, a mouse, a microphone, or the like. In addition, the output section 306 includes an LCD (Liquid Crystal Display), a speaker, or the like.

Here, processes that are performed by a computer according to a program in the present specification need not necessarily be performed in a time series along the order described as a flowchart. That is, processes that are performed by a computer according to a program also include processes that are executed in parallel or individually (e.g., parallel processes or processes performed by objects).

In addition, a program may be processed by one computer (processor) or may be processed in a distributed manner by multiple computers. Further, a program may be transferred to and executed on a remote computer.

Moreover, in the present specification, a system means a set of multiple constituent elements (apparatuses, modules (components), etc. ), and it does not matter whether or not all the constituent elements are in a single housing. Accordingly, both multiple apparatuses that are housed in separate housings and are connected to each other via a network and one apparatus including multiple modules that are housed in one housing are systems.

In addition, for example, a configuration explained as one apparatus (or processing section) may be divided, and configured as multiple apparatuses (or processing sections). In contrast, configurations that are explained as multiple apparatuses (or processing sections) above may be put together, and configured as one apparatus (or processing section). In addition, needless to say, the configuration of each apparatus (or each processing section) may have additional configurations other than those described above. Further, as long as substantially the same configurations and actions can be achieved as a whole system, some of configurations of an apparatus (or a processing section) may be included in the configuration of another apparatus (or another processing section).

In addition, for example, the present technology can have a configuration of cloud computing that processes one functionality in a shared and cooperative manner by multiple apparatuses via a network.

In addition, for example, the program described above can be executed in any apparatus. In this case, it is sufficient if the apparatus has necessary functions (functional blocks, etc.) and can obtain necessary information.

In addition, for example, other than being executed by one apparatus, each step explained with reference to the flowcharts described above can be executed in a shared manner by multiple apparatuses. Further, in a case where one step includes multiple processes, other than being executed by one apparatus, the multiple processes included in the one step can be executed in a shared manner by multiple apparatuses. Stated differently, multiple processes included in one step can also be execute as processes to be performed at multiple steps. In contrast, processes explained as multiple steps can also be put together, and executed as one step.

Note that processes of steps describing a program executed by a computer may be executed in a time series along an order explained in the present specification, or may be executed in parallel or individually at necessary timings such as when they are called. That is, unless contradiction occurs, processes of respective steps may be executed in an order different from an order described above. Further, the processes of the steps describing the program may be executed in parallel with processes of another program or may be executed in combination with processes of another program.

Note that multiple aspects of the present technology explained in the present specification can be implemented individually and independently unless contradiction arises.

Needless to say, any ones of the multiple aspects of the present technology can also be implemented in combination. For example, part or the whole of the present technology explained in any of embodiments can also be implemented in combination with part or the whole of the present technology explained in another embodiment. In addition, any part or the whole of the present technology described above can also be implemented in combination with another technique not described above.

### <Examples of Combinations of Configurations>

Note that the present technology can also adopt configurations like the ones below.

(1)

An information processing apparatus including:
a communicating section that communicates with another information processing apparatus;
an operation data acquiring section that acquires driving operation data representing an operation amount of driving operation performed on multiple types of operation systems for operating a vehicle;
a vehicle action control section that supplies a control signal to multiple types of drive systems that drive the vehicle and controls an action performed by the vehicle;
a travel mode control section that, in a travel mode in which traveling is performed using the vehicle, supplies, to the vehicle action control section, control data for controlling traveling of the vehicle according to the driving operation data;
a simulation mode control section that, in a simulation mode in which driving simulation is performed using the vehicle, supplies, to the vehicle action control section, control data for controlling a behavior of the vehicle such that a behavior of the vehicle in a virtual space determined according to the driving operation data is reproduced, on the basis of a vehicle setting parameter acquired via the communicating section from the other information processing apparatus; and
a stopped state deciding section that, when operation for giving an instruction to switch from the travel mode to the simulation mode is performed, decides whether or not to transition to the simulation mode, according to a stopped state of the vehicle.
   (2)

The information processing apparatus according to (1) above, in which
at least one of multiple types of the operation systems and at least one of multiple types of the drive systems corresponding to the one of multiple types of the operation systems are linked with each other by-wire, and
the drive system linked by-wire with the one of the operation systems is configured not to perform an action even if driving operation on the one of the operation systems is performed in the simulation mode.
   (3)

The information processing apparatus according to (1) or (2) above, in which,
in a case where operation for giving the instruction to switch from the travel mode to the simulation mode is performed when the vehicle is stopped, the stopped state deciding section decides to transition to the simulation mode.
   (4)

The information processing apparatus according to any one of (1) to (3) above, further including:
a vehicle internal environment recognizing section that recognizes a position and a posture of an occupant of the vehicle on the basis of sensor data and video data supplied from a sensor and a camera provided to the vehicle and acquires occupant position/posture data including at least a viewpoint position of the occupant, in which
the communicating section transmits the occupant position/posture data to the other information processing apparatus.
   (5)

The information processing apparatus according to (4) above in which
the vehicle is able to execute driving simulation in a state where the vehicle is garaged in a garage apparatus including a garage display that displays a video in such a manner to surround the vehicle, and
a simulation video in which driving simulation of virtual traveling of the vehicle in the virtual space according to the driving operation data is performed is displayed on the garage display, the simulation video being generated by capturing images of the virtual space in all directions with the vehicle as a center by a virtual camera arranged in the virtual space such that the virtual camera corresponds to a predetermined position of the vehicle, geometric transformation being implemented on the simulation video depending on a viewpoint of the occupant on the basis of vehicle position/posture data representing a position and a posture of the vehicle and the occupant position/posture data.
   (6)

The information processing apparatus according to (5) above, in which
the vehicle includes a side mirror display that displays a side mirror video captured in a rear direction of the vehicle by a side mirror camera installed on a side of the vehicle, and,
in the simulation mode, a virtual side mirror video generated by capturing images of the virtual space in the rear direction of the vehicle by a virtual camera arranged on the side of the vehicle in the virtual space is displayed on the side mirror display.
   (7)

The information processing apparatus according to (5) or (6) above, in which
the vehicle includes a rearview mirror display that displays a rearview mirror video captured in a rear direction of the vehicle by a rearview mirror camera installed on a rear side of the vehicle, and,
in the simulation mode, a virtual rearview mirror video generated by capturing images of the virtual space in the rear direction of the vehicle by a virtual camera arranged on the rear side of the vehicle in the virtual space is displayed on the rearview mirror display.
   (8)

The information processing apparatus according to any one of (5) to (7) above, in which
the vehicle includes a rear seat display provided to a rear seat of the vehicle, and,
in the simulation mode, a rear seat viewpoint video generated by capturing images of the virtual space seen ahead of the rear seat display by a virtual camera arranged in the virtual space such that the virtual camera corresponds to a viewpoint of an occupant of the rear seat according to the occupant position/posture data is displayed on the rear seat display.
   (9)

An information processing method executed by an information processing apparatus, the information processing method including:
communicating with another information processing apparatus;
acquiring driving operation data representing an operation amount of driving operation performed on multiple types of operation systems for operating a vehicle;
supplying a control signal to multiple types of drive systems that drive the vehicle and controlling an action performed by the vehicle;
in a travel mode in which traveling is performed using the vehicle, causing an action performed by the vehicle to be controlled according to control data for controlling traveling of the vehicle according to the driving operation data;
in a simulation mode in which driving simulation is performed using the vehicle, causing an action performed by the vehicle to be controlled according to control data for controlling a behavior of the vehicle such that a behavior of the vehicle in the virtual space determined according to the driving operation data is reproduced, on the basis of a vehicle setting parameter acquired by communication from the other information processing apparatus; and
when operation for giving an instruction to switch from the travel mode to the simulation mode is performed, deciding whether or not to transition to the simulation mode, according to a stopped state of the vehicle.
   (10)

A program for causing a computer of an information processing apparatus to execute information processing, the information processing including:
communicating with another information processing apparatus;
acquiring driving operation data representing an operation amount of driving operation performed on multiple types of operation systems for operating a vehicle;
supplying a control signal to multiple types of drive systems that drive the vehicle and controlling an action performed by the vehicle;
in a travel mode in which traveling is performed using the vehicle, causing an action performed by the vehicle to be controlled according to control data for controlling traveling of the vehicle according to the driving operation data;
in a simulation mode in which driving simulation is performed using the vehicle, causing an action performed by the vehicle to be controlled according to control data for controlling a behavior of the vehicle such that a behavior of the vehicle in the virtual space determined according to the driving operation data is reproduced, on the basis of a vehicle setting parameter acquired by communication from the other information processing apparatus; and
when operation for giving an instruction to switch from the travel mode to the simulation mode is performed, deciding whether or not to transition to the simulation mode, according to a stopped state of the vehicle.
   (11)

An information processing apparatus including:
a communicating section that communicates with another information processing apparatus mounted on a vehicle;
a virtual space generating section that performs driving simulation of virtual traveling of the vehicle in a virtual space according to driving operation data acquired from the vehicle via the communicating section and generates a simulation video by capturing images of the virtual space in all directions with the vehicle as a center by a virtual camera arranged in the virtual space such that the virtual camera corresponds to a predetermined position of the vehicle; and
a video transformation processing section that implements, on the simulation video, video transformation processing based on vehicle position/posture data representing a position and a posture of the vehicle and occupant position/posture data including at least a viewpoint position of an occupant of the vehicle.
   (12)

The information processing apparatus according to (11) above, in which
the virtual space generating section determines a behavior of the vehicle in the virtual space, generates a vehicle setting parameter for controlling a behavior of the vehicle in such a manner as to reproduce the behavior, and causes the vehicle Setting parameter to be transmitted to the vehicle via the communicating section.
   (13)

The information processing apparatus according to (11) or (12) above, in which
the vehicle is able to execute driving simulation in a state where the vehicle is garaged in a garage apparatus including a garage display that displays a video in such a manner as to surround the vehicle, and
a simulation video output from the video transformation processing section is displayed on the garage display.
   (14)

The information processing apparatus according to (13) above, in which
the video transformation processing section has
   a viewpoint sensing section that specifies a viewpoint position of the occupant relative to the garage display by setting a cuboid space in which the vehicle is inscribed, at a position of the vehicle relative to the garage display on the basis of the vehicle position/posture data, and setting a viewpoint position of the occupant relative to the cuboid space on the basis of the occupant position/posture data, and
   a geometric transforming section that implements such geometric transformation that the simulation video generated at the virtual space generating section is projected onto the garage display as a projection plane, by using the viewpoint position of the occupant specified by the viewpoint sensing section, as a reference position.
      (15)

The information processing apparatus according to (14) above, in which
the virtual space generating section generates a virtual side mirror video generated by capturing images of the virtual space in a rear direction of the vehicle by a virtual camera arranged on a side of the vehicle in the virtual space, causes the virtual side mirror video to be transmitted to the vehicle via the communicating section, and causes a side mirror display of the vehicle to display the virtual side mirror video.
   (16)

The information processing apparatus according to (14) or (15) above, in which
the virtual space generating section generates a virtual rearview mirror video generated by capturing images of the virtual space in a rear direction of the vehicle by a virtual camera arranged on a rear side of the vehicle in the virtual space, causes the virtual rearview mirror video to be transmitted to the vehicle via the communicating section, and causes a rearview mirror display of the vehicle to display the virtual rearview mirror video.
   (17)

The information processing apparatus according to any one of (14) to (16) above, in which
the virtual space generating section generates a rear seat viewpoint video generated by capturing images of the virtual space seen ahead of a rear seat display provided to a rear seat of the vehicle, by a virtual camera arranged in the virtual space such that the virtual camera corresponds to a viewpoint of an occupant of the rear seat of the vehicle according to the occupant position/posture data, causes the rear seat viewpoint video to be transmitted to the vehicle via the communicating section, and causes the rear seat display to display the rear seat viewpoint video.
   (18)

An information processing method executed by an information processing apparatus, the information processing method including:
communicating with another information processing apparatus mounted on a vehicle;
performing driving simulation of virtual traveling of the vehicle in a virtual space according to driving operation data acquired from the vehicle by the communication and generating a simulation video by capturing images of the virtual space in all directions with the vehicle as a center by a virtual camera arranged in the virtual space such that the virtual camera corresponds to a predetermined position of the vehicle; and
implementing, on the simulation video, video transformation processing based on vehicle position/posture data representing a position and a posture of the vehicle and occupant position/posture data including at least a viewpoint position of an occupant of the vehicle.
   (19)

A program for causing a computer of an information processing apparatus to execute information processing, the information processing including:
communicating with another information processing apparatus mounted on a vehicle;
performing driving simulation of virtual traveling of the vehicle in a virtual space according to driving operation data acquired from the vehicle by the communication and generating a simulation video by capturing images of the virtual space in all directions with the vehicle as a center by a virtual camera arranged in the virtual space such that the virtual camera corresponds to a predetermined position of the vehicle; and
implementing, on the simulation video, video transformation processing based on vehicle position/posture data representing a position and a posture of the vehicle and occupant position/posture data including at least a viewpoint position of an occupant of the vehicle.

Note that the present embodiments are not limited to the embodiments described above, and can be changed in various manners within the scope not deviating from the gist of the present disclosure. In addition, advantages described in the present specification are illustrated merely as examples and are not the sole examples, and there may be other advantages.

### REFERENCE SIGNS LIST

11: Driving simulation system
12: Garage system
13: Vehicle
14: Garage apparatus
15: Charging apparatus
16: Garage system control apparatus
17: Home server
18: In-vehicle control apparatus
19: Motive power source
21: Steering wheel
22: Accelerator pedal
23: Brake pedal
24: Axial-direction steering section
25: Throttle motor
26: Brake
27: Steering wheel rotation sensor
28: Accelerator position sensor
29: Brake position sensor
30: Axial-direction drive mechanism
31: Throttle drive mechanism
32: Brake drive mechanism
33: Steering wheel reaction force drive mechanism
34: Accelerator reaction force drive mechanism
35: Brake reaction force drive mechanism
36: Suspension drive mechanism
37: Seat drive mechanism
41: Garage display
42: Garage camera
43: Garage sensor
51: Navigation display
52: Side mirror display
53: Instrument panel display
54: Rearview mirror display
55: Rear seat display
56: In-vehicle camera
57: In-vehicle sensor
58: Speaker

1. An information processing apparatus comprising:
a communicating section that communicates with another information processing apparatus;
an operation data acquiring section that acquires driving operation data representing an operation amount of driving operation performed on multiple types of operation systems for operating a vehicle;
a vehicle action control section that supplies a control signal to multiple types of drive systems that drive the vehicle and controls an action performed by the vehicle;
a travel mode control section that, in a travel mode in which traveling is performed using the vehicle, supplies, to the vehicle action control section, control data for controlling traveling of the vehicle according to the driving operation data;
a simulation mode control section that, in a simulation mode in which driving simulation is performed using the vehicle, supplies, to the vehicle action control section, control data for controlling a behavior of the vehicle such that a behavior of the vehicle in a virtual space determined according to the driving operation data is reproduced, on a basis of a vehicle setting parameter acquired via the communicating section from the other information processing apparatus; and
a stopped state deciding section that, when operation for giving an instruction to switch from the travel mode to the simulation mode is performed, decides whether or not to transition to the simulation mode, according to a stopped state of the vehicle.

2. The information processing apparatus according to claim 1, wherein
at least one of multiple types of the operation systems and at least one of multiple types of the drive systems corresponding to the one of multiple types of the operation systems are linked with each other by-wire, and
the drive system linked by-wire with the one of the operation systems is configured not to perform an action even if driving operation on the one of the operation systems is performed in the simulation mode.

3. The information processing apparatus according to claim 1, wherein,
in a case where operation for giving the instruction to switch from the travel mode to the simulation mode is performed when the vehicle is stopped, the stopped state deciding section decides to transition to the simulation mode.

4. The information processing apparatus according to claim 1, further comprising:
a vehicle internal environment recognizing section that recognizes a position and a posture of an occupant of the vehicle on a basis of sensor data and video data supplied from a sensor and a camera provided to the vehicle and acquires occupant position/posture data including at least a viewpoint position of the occupant, wherein
the communicating section transmits the occupant position/posture data to the other information processing apparatus.

5. The information processing apparatus according to claim 4, wherein
the vehicle is able to execute driving simulation in a state where the vehicle is garaged in a garage apparatus including a garage display that displays a video in such a manner to surround the vehicle, and
a simulation video in which driving simulation of virtual traveling of the vehicle in the virtual space according to the driving operation data is performed is displayed on the garage display, the simulation video being generated by capturing images of the virtual space in all directions with the vehicle as a center by a virtual camera arranged in the virtual space such that the virtual camera corresponds to a predetermined position of the vehicle, geometric transformation being implemented on the simulation video depending on a viewpoint of the occupant on a basis of vehicle position/posture data representing a position and a posture of the vehicle and the occupant position/posture data.

6. The information processing apparatus according to claim 5, wherein
the vehicle includes a side mirror display that displays a side mirror video captured in a rear direction of the vehicle by a side mirror camera installed on a side of the vehicle, and,
in the simulation mode, a virtual side mirror video generated by capturing images of the virtual space in the rear direction of the vehicle by a virtual camera arranged on the side of the vehicle in the virtual space is displayed on the side mirror display.

7. The information processing apparatus according to claim 5, wherein
the vehicle includes a rearview mirror display that displays a rearview mirror video captured in a rear direction of the vehicle by a rearview mirror camera installed on a rear side of the vehicle, and,
in the simulation mode, a virtual rearview mirror video generated by capturing images of the virtual space in the rear direction of the vehicle by a virtual camera arranged on the rear side of the vehicle in the virtual space is displayed on the rearview mirror display.

8. The information processing apparatus according to claim 5, wherein
the vehicle includes a rear seat display provided to a rear seat of the vehicle, and,
in the simulation mode, a rear seat viewpoint video generated by capturing images of the virtual space seen ahead of the rear seat display by a virtual camera arranged in the virtual space such that the virtual camera corresponds to a viewpoint of an occupant of the rear seat according to the occupant position/posture data is displayed on the rear seat display.

9. An information processing method executed by an information processing apparatus, the information processing method comprising:
communicating with another information processing apparatus;
acquiring driving operation data representing an operation amount of driving operation performed on multiple types of operation systems for operating a vehicle;
supplying a control signal to multiple types of drive systems that drive the vehicle and controlling an action performed by the vehicle;
in a travel mode in which traveling is performed using the vehicle, causing an action performed by the vehicle to be controlled according to control data for controlling traveling of the vehicle according to the driving operation data;
in a simulation mode in which driving simulation is performed using the vehicle, causing an action performed by the vehicle to be controlled according to control data for controlling a behavior of the vehicle such that a behavior of the vehicle in the virtual space determined according to the driving operation data is reproduced, on a basis of a vehicle setting parameter acquired by communication from the other information processing apparatus; and
when operation for giving an instruction to switch from the travel mode to the simulation mode is performed, deciding whether or not to transition to the simulation mode, according to a stopped state of the vehicle.

10. A program for causing a computer of an information processing apparatus to execute information processing, the information processing comprising:
communicating with another information processing apparatus;
acquiring driving operation data representing an operation amount of driving operation performed on multiple types of operation systems for operating a vehicle;
supplying a control signal to multiple types of drive systems that drive the vehicle and controlling an action performed by the vehicle;
in a travel mode in which traveling is performed using the vehicle, causing an action performed by the vehicle to be controlled according to control data for controlling traveling of the vehicle according to the driving operation data;
in a simulation mode in which driving simulation is performed using the vehicle, causing an action performed by the vehicle to be controlled according to control data for controlling a behavior of the vehicle such that a behavior of the vehicle in the virtual space determined according to the driving operation data is reproduced, on a basis of a vehicle setting parameter acquired by communication from the other information processing apparatus; and
when operation for giving an instruction to switch from the travel mode to the simulation mode is performed, deciding whether or not to transition to the simulation mode, according to a stopped state of the vehicle.

11. An information processing apparatus comprising:
a communicating section that communicates with another information processing apparatus mounted on a vehicle;
a virtual space generating section that performs driving simulation of virtual traveling of the vehicle in a virtual space according to driving operation data acquired from the vehicle via the communicating section and generates a simulation video by capturing images of the virtual space in all directions with the vehicle as a center by a virtual camera arranged in the virtual space such that the virtual camera corresponds to a predetermined position of the vehicle; and
a video transformation processing section that implements, on the simulation video, video transformation processing based on vehicle position/posture data representing a position and a posture of the vehicle and occupant position/posture data including at least a viewpoint position of an occupant of the vehicle.

12. The information processing apparatus according to claim 11, wherein
the virtual space generating section determines a behavior of the vehicle in the virtual space, generates a vehicle setting parameter for controlling a behavior of the vehicle in such a manner as to reproduce the behavior, and causes the vehicle setting parameter to be transmitted to the vehicle via the communicating section.

13. The information processing apparatus according to claim 11, wherein
the vehicle is able to execute driving simulation in a state where the vehicle is garaged in a garage apparatus including a garage display that displays a video in such a manner as to surround the vehicle, and
a simulation video output from the video transformation processing section is displayed on the garage display.

14. The information processing apparatus according to claim 13, wherein
the video transformation processing section has
a viewpoint sensing section that specifies a viewpoint position of the occupant relative to the garage display by setting a cuboid space in which the vehicle is inscribed, at a position of the vehicle relative to the garage display on a basis of the vehicle position/posture data, and setting a viewpoint position of the occupant relative to the cuboid space on a basis of the occupant position/posture data, and
a geometric transforming section that implements such geometric transformation that the simulation video generated at the virtual space generating section is projected onto the garage display as a projection plane, by using the viewpoint position of the occupant specified by the viewpoint sensing section, as a reference position.

15. The information processing apparatus according to claim 14, wherein
the virtual space generating section generates a virtual side mirror video generated by capturing images of the virtual space in a rear direction of the vehicle by a virtual camera arranged on a side of the vehicle in the virtual space, causes the virtual side mirror video to be transmitted to the vehicle via the communicating section, and causes a side mirror display of the vehicle to display the virtual side mirror video.

16. The information processing apparatus according to claim 14, wherein
the virtual space generating section generates a virtual rearview mirror video generated by capturing images of the virtual space in a rear direction of the vehicle by a virtual camera arranged on a rear side of the vehicle in the virtual space, causes the virtual rearview mirror video to be transmitted to the vehicle via the communicating section, and causes a rearview mirror display of the vehicle to display the virtual rearview mirror video.

17. The information processing apparatus according to claim 14, wherein
the virtual space generating section generates a rear seat viewpoint video generated by capturing images of the virtual space seen ahead of a rear seat display provided to a rear seat of the vehicle, by a virtual camera arranged in the virtual space such that the virtual camera corresponds to a viewpoint of an occupant of the rear seat of the vehicle according to the occupant position/posture data, causes the rear seat viewpoint video to be transmitted to the vehicle via the communicating section, and causes the rear seat display to display the rear seat viewpoint video.

18. An information processing method executed by an information processing apparatus, the information processing method comprising:
communicating with another information processing apparatus mounted on a vehicle;
performing driving simulation of virtual traveling of the vehicle in a virtual space according to driving operation data acquired from the vehicle by the communication and generating a simulation video by capturing images of the virtual space in all directions with the vehicle as a center by a virtual camera arranged in the virtual space such that the virtual camera corresponds to a predetermined position of the vehicle; and
implementing, on the simulation video, video transformation processing based on vehicle position/posture data representing a position and a posture of the vehicle and occupant position/posture data including at least a viewpoint position of an occupant of the vehicle.

19. A program for causing a computer of an information processing apparatus to execute information processing, the information processing comprising:
communicating with another information processing apparatus mounted on a vehicle;
performing driving simulation of virtual traveling of the vehicle in a virtual space according to driving operation data acquired from the vehicle by the communication and generating a simulation video by capturing images of the virtual space in all directions with the vehicle as a center by a virtual camera arranged in the virtual space such that the virtual camera corresponds to a predetermined position of the vehicle; and
implementing, on the simulation video, video transformation processing based on vehicle position/posture data representing a position and a posture of the vehicle and occupant position/posture data including at least a viewpoint position of an occupant of the vehicle.
